(19) United States
(12) Patent Application Publication
(10) Pub. No.: US 2014/0044085 A1
(43) Pub. Date: Feb. 13, 2014

(54) APPARATUS AND METHOD FOR TRANSMITTING RESOURCE ALLOCATION INFORMATION

(71) Applicant: Sung Kwon Hong, Seoul (KR)

(72) Inventor: Sung Kwon Hong, Seoul (KR)

(73) Assignee: Pantech Co., Ltd, Seoul (KR)

(21) Appl. No.: 14/113,262

(22) PCT Filed: Mar. 7, 2012
(86) PCT No.: PCT/KR2012/001664

§ 371 Date: Oct. 22, 2013

(30) Foreign Application Priority Data
May 2, 2011 (KR) 10-2011-004707
Jul. 29, 2011 (KR) 10-2011-0076229

(51) Int. Cl. H04L 5/00

(52) U.S. Cl. CPC H04L 5/0037
USPC 370/329

(57) ABSTRACT

The present invention relates to a method and an apparatus for dynamically configuring a resource allocation unit within a PDCCH for an effective resource allocation of multiple cell or multiple component carriers, the method comprising the steps of: configuring at least one carrier in a terminal; and transmitting, using a single control channel, resource allocation information for indicating resource blocks concatenated to at least one component carrier and allocated as data channels, wherein the resource allocation information comprises information about the size of a resource block group which defines the basic unit of allocation for the concatenated resource blocks.

### CROSS-REFERENCE TO RELATED APPLICATIONS

This application is the National Stage Entry of International Application PCT/KR2012/001664, filed on Mar. 7, 2012, and claims priority from and the benefit of Korean Patent Application No. 10-2011-0041707, filed on May 2, 2011 and Korean Patent Application No. 10-2011-0076229, filed on Jul. 29, 2011, all of which are incorporated herein by reference in their entireties for all purposes as if fully set forth herein.

### BACKGROUND

1. Field

The present invention relates to wireless communication, and more specifically, to an apparatus and method of transmitting resource allocation information in a wireless is communication system.

2. Discussion of the Background

In general, 3GPP (3^{rd} Generation Partnership Project) LTE (Long Term Evolution) transmits resource allocation information for allocating user equipment (UE)-specific resources, as well as control information for uplink or downlink communication through a physical downlink control channel that is transmitted on downlink.

A radio resource is represented as blocks split in the time-frequency plane, i.e., as resource blocks, and such a resource block may be the aggregation of sub-carriers for a specific time.

In order to effectively utilize limited radio resources, a base station (eNodeB) schedules radio resources. The base station increases efficiency of use of radio resources through dynamic scheduling for dynamically allocating radio resources according to the amount of data to be transmitted or received or depending on whether there is data to be transmitted or received.

Meanwhile, as broadband communication is in service, more radio resources (resource blocks) are demanded, and more bits for transmitting resource allocation information are required.

### SUMMARY

An object of the present invention is to provide a method of efficiently performing resource allocation for multiple cells or multiple component carriers.

An object of the present invention is to provide a method of variably configuring a resource allocation basis in a PDCCH.

An object of the reception is to provide a method of being able to allocate a is resource on fewer PDCCHs than multiple component carriers for the multiple component carriers.

An object of the present invention is to provide a method of being able to allocate fewer PDCCHs than multiple associated cells for the multiple associated cells.

An object of the present invention is to allocate a PDSCH region in one or more component carriers or cells or transmission points using a PDCCH.

The present invention concerns a resource allocation method. According to an aspect of the present invention includes configuring a cell group and transmitting UE-specific resource allocation information through a single control channel, wherein the resource allocation information includes information regarding concatenating resource blocks allocated to cells constituting the cell group and allocating it to a UE.

Here, the cell group may be constituted of component carriers selected from among component carriers configured in a multiple component carriers system, and the resource allocation information may include information regarding concatenating resource blocks allocated to component carriers constituting a cell group and allocating to a UE.

Further, the cell group may consist of cells selected from among coordinated cells in a coordinated multiple point (CoMP) system, and the coordinated cells may include at least one of a primary serving cell, a neighboring cell of the primary serving cell, a micro cell inside or outside the primary serving cell, a remote radio head (RRH) inside or outside the primary serving cell, and a relay inside or outside the primary serving cell.

The resource allocation information may include information regarding a size of a resource block group constituted of coordinated resource blocks and may be transmitted in a code point.

The transmitted code point may indicate information on a configurable cell group and/or information regarding a resource block group and a cell group corresponding on an information set including information on a resource block group that may be allocated in combination with the cell group.

Here, the information on the resource block group may be information on the size of the resource block group.

The present invention concerns a method of obtaining a resource. An aspect of the present invention includes receiving resource allocation information through a single control channel and obtaining a resource having a size indicated by the resource allocation information as a resource block group obtained by concatenating resource blocks allocated to a cell group indicated by the resource allocation information.

Here, the cell group may be constituted of component carriers selected from among component carriers configured in a multiple component carriers system, and in the step of obtaining a resource, a resource block group may be obtained that begins from an uplink and downlink component carrier corresponding to a component carrier indicated by a carrier indicator field among component carriers constituting a cell group and that has a size indicated by the resource allocation information.

Further, in the step of obtaining a resource, a resource block group having a size indicated by the resource allocation information may be obtained by concatenating resource allocation regions of uplink and downlink cells corresponding to each cell in the order of an index of each of cells constituting the cell group. Such case may be when no carrier indicator field is present in the physical downlink control channel (PDCCH) and no cross-carrier scheduling exists.

Another aspect of a method of obtaining a resource according to the present invention includes receiving resource allocation information on a single control channel and obtaining a resource having a size calculated based on a configuration of a cell group as all of the resource blocks or resource block groups obtained by concatenating resource blocks allocated to a cell group indicated by the resource allocation information.

Here, in the step of obtaining a resource, the resource may be acquired so that the size of the concatenated resource block group is equal to a result obtained by dividing all of the resource blocks for the cell group by resource block groups of a reference cell.

Here, the reference cell may be determined as a cell having a maximum band among cells constituting the cell group, as a cell having a predetermined band, or as a cell where a control channel is transmitted.

In the present aspect, the cell group may be constituted of component carriers selected from among component carriers configured in a multiple component carriers system, and in the step of obtaining a resource, a resource block group may be obtained that begins from an uplink and downlink component carrier corresponding to a component carrier indicated by a carrier indicator field among component carriers constituting a cell group and that has a size indicated by the resource allocation information.

Further, in the step of obtaining a resource, a resource block group having a size calculated may be obtained by concatenating resource allocation regions of uplink cells corresponding to each cell in the order of an index of each of cells constituting the cell group. Such case may be when no carrier indicator field is present in the physical downlink control channel (PDCCH) and no cross-carrier scheduling exists.

Still another aspect of the present invention is directed to a method of transmitting a control channel by a base station in a wireless communication system, the method comprising mapping downlink control information including a carrier indicator field to a physical downlink control channel, transmitting the physical downlink control channel to a UE, and transmitting to the UE a plurality of physical downlink shared channels mapped to the physical downlink control channel in a one-to-plural correspondence. The carrier identifier field indicates a combination of a plurality of component carriers, and the plurality of physical downlink shared channels are distributed to the plurality of component carriers, respectively, and may be transmitted to the UE.

Still another aspect of the present invention concerns a method of transmitting resource allocation information by a base station, the method comprising configuring at least one component carrier for a UE and transmitting through a single control channel resource allocation information indicating resource blocks concatenated over the at least one component carrier and allocated to a data channel, wherein the resource allocation information includes information on a size of a resource block group defining a basis on which the concatenated resource blocks are allocated.

A group of component carriers consists of cells selected from coordinated cells in a coordinated multiple point (CoMP) system, wherein the coordinated cells may include at least one of a primary serving cell, a neighboring cell of the primary serving cell, a micro cell inside or outside the primary serving cell, a remote radio head (RRH) inside or outside the primary serving cell, and a relay inside or outside the primary serving cell.

The resource allocation information is represented as a code point, and the code point may indicate a size of a resource block group applied to a group constituted of the at least one component carrier.

The size of a resource block group may be determined as a size of a resource block group defined in a band of a basic component carrier of the at least one component carrier.

Yet still another aspect of the present invention concerns a method of receiving resource allocation information by a UE, the method comprising configuring at least one component carrier and receiving through a single control channel resource allocation information indicating resource blocks concatenated over the at least one component carrier and allocated to a data channel, wherein the resource allocation information includes information on a size of a resource block group defining a basis on which the concatenated resource blocks are allocated.

A group of component carriers consists of cells selected from coordinated cells in a coordinated multiple point (CoMP) system, wherein the coordinated cells may include at least one of a primary serving cell, a neighboring cell of the primary serving cell, a micro cell inside or outside the primary serving cell, a remote radio head (RRH) inside or outside the primary serving cell, and a relay inside or outside the primary serving cell.

The resource allocation information may be represented as a code point, and the code point may indicate a size of a resource block group applied to a group constituted of the at least one component carrier.

The size of a resource block group may be determined as a size of a resource block group defined in a band of a basic component carrier of the at least one component carrier.

Yet still another aspect of the present invention concerns a base station transmitting resource allocation information, the base station comprising a processor configuring at least one component carrier for a UE and an RF (Radio Frequency) unit transmitting through a single control channel resource allocation information indicating resource blocks concatenated over the at least one component carrier and allocated to a data channel, wherein the resource allocation information includes information on a size of a resource block group defining a basis on which the concatenated resource blocks are allocated.

A group of component carriers may consist of cells selected from coordinated cells in a coordinated multiple point (CoMP) system, wherein the coordinated cells may include at least one of a primary serving cell, a neighboring cell of the primary serving cell, a micro cell inside or outside the primary serving cell, a remote radio head (RRH) inside or outside the primary serving cell, and a relay inside or outside the primary serving cell.

The resource allocation information may be represented as a code point, and the code point may indicate a size of a resource block group applied to a group constituted of the at least one component carrier.

The size of a resource block group may be determined as a size of a resource block group defined in a band of a basic component carrier of the at least one component carrier.

Yet still another aspect of the present invention concerns a UE receiving resource allocation information, the UE comprising a processor configuring at least one component carrier and an RF unit receiving through a single control channel resource allocation information indicating resource blocks concatenated over the at least one component carrier and allocated to a data channel, wherein the resource allocation information includes information on a size of a resource block group defining a basis on which the concatenated resource blocks are allocated.

A group of component carriers may consist of cells selected from coordinated cells in a coordinated multiple point (CoMP) system, wherein the coordinated cells may include at least one of a primary serving cell, a neighboring cell of the primary serving cell, a micro cell inside or outside the primary serving cell, a remote radio head (RRH) inside or outside the primary serving cell, and a relay inside or outside the primary serving cell.

The size of a resource block group may be determined as a size of a resource block group defined in a band of a basic component carrier of the at least one component carrier.

According to the present invention, resource allocation for multiple cells or multiple component carriers may be efficiently performed by variably configuring a resource allocation basis in a PDCCH.

According to the present invention, resources may be allocated to multiple component carriers on fewer PDCCHs than the multiple component carriers.

According to the present invention, resources may be allocated to multiple associated cells on fewer PDCCHs than the multiple associated cells.

### BRIEF DESCRIPTION OF DRAWINGS

FIG. 1 shows the structure of a downlink sub-frame to which the present invention applies;

FIG. 2 is a view illustrating an example of a resource grid for one downlink slot to which the present invention applies;

FIG. 3 is a view schematically illustrating a type 0 resource allocation scheme among resource allocation schemes to which the present invention applies;

FIG. 4 is a view schematically illustrating a type 2 resource allocation scheme among resource allocation schemes to which the present invention applies;

FIG. 5 is a view schematically illustrating an example of cross-carrier scheduling in carrier aggregation;

FIG. 6 is a view schematically illustrating an example in which there is no cross-carrier scheduling in carrier aggregation;

FIG. 7 is a view schematically illustrating a method of varying the size of a resource block group to be scheduled in a system to which the present invention applies;

FIG. 8 is a view schematically illustrating an example of a CoMP system to which the present invention applies;

FIG. 9 is a flowchart schematically illustrating an operation performed by a base station in a system to which the present invention applies;

FIG. 10 is a flowchart schematically illustrating an operation performed by a UE in a system to which the present invention applies; and

FIG. 11 is a block diagram schematically illustrating the configuration of a UE and a base station in a system to which the present invention applies.

### DETAILED DESCRIPTION OF THE ILLUSTRATED EMBODIMENTS

Hereinafter, some embodiments in the instant disclosure will be described in detail with reference to the accompanying drawings. The same reference numerals may be used to denote the same or substantially the same elements throughout the specification and the drawings. When determined to make the subject matter of this disclosure unnecessarily unclear, the detailed description of the related prior art will be skipped.

In this disclosure, a wireless communication network will be described, and any task performed in the wireless communication network may be done while the network is controlled or data is transmitted/received by a system (e.g., a base station) that is in charge of the wireless communication network or by a UE linked to the wireless communication network.

According to embodiments of the present invention, the phrase “transmit(ting) a channel” may be construed as transmitting information through a specific channel. Here, the “channel” includes a control channel and a data channel. The control channel may be, for example, a physical downlink control channel (PDCCH) or a physical uplink control channel (PUCCH), and the data channel may be, for example, a physical downlink shared channel (PDSCH) or a physical uplink shared channel (PUSCH).

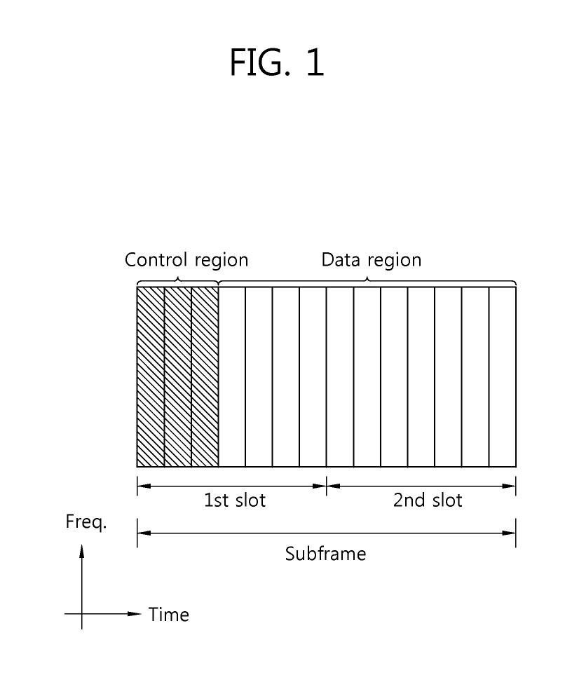

FIG. 1 shows the structure of a downlink sub-frame to which the present invention applies.

Referring to FIG. 1, the sub-frame includes two slots. In the first slot of the sub-frame, first two or three OFDM symbols are a control region in which a PDCCH is allocated, and the remaining OFDM symbols are a data region in which a PDSCH is allocated.

The downlink physical control channel includes, in addition to the PDCCH, a PCFICH (Physical Control Format Indicator Channel) or a PHICH (Physical Hybrid-ARQ Indicator Channel). Among them, the PDCCH is used in 3GPP LTE to deliver control information for uplink/downlink communication and resource allocation information for a resource allocated to each UE in the frequency and time domains.

Specifically, the PDCCH delivers HARQ (Hybrid Automatic Repeat request) information related to the PDSCH and resource allocation of the PDSCH and a PCH (Paging CHannel) to the UE. The PDCCH may carry an uplink grant indicating resource allocation of uplink transmission to the UE and a downlink grant informing resource allocation of downlink transmission to the UE. Here, the physical channel for transmitting a type indicator indicating the type of the PDCCH, that is, the number of OFDM symbols constituting the PDCCH to the UE is the PCFICH. The PCFICH is included in each sub-frame. The type indicator may also be referred to as control format indicator (CFI). Meanwhile, the PHICH carries an ACK (Acknowledgement)/NACK (Not-Acknowledgement) signal for an uplink HARQ.

A plurality of PDCCHs may be transmitted in the control region, and the UE may monitor the plurality of PDCCHs. The PDCCH is transmitted on one CCE (Control Channel Element) or the aggregation of a few contiguous CCEs. The CCE is a physical allocation basis used for providing a coding rate according to the state of a radio channel to the PDCCH. The CCE corresponds to a plurality of resource element groups. In accordance with the relationship between the number of CCEs and the coding rate provided by the CCEs, the format of a PDCCH and the number of bits of a possible PDCCH are determined.

The control information transmitted through the PDCCH is referred to as downlink control information (hereinafter, “DCI”). The DCI has different uses and different fields defined therein depending on its format. Table 1 shows DCI formats.

TABLE 1

| DCI | |
|---|---|
| format | Description |
| 0 | Used for scheduling PUSCH(uplink grant) |
| 1 | Used for scheduling one PDSCH codeword in one cell |
| 1A | Used for brief scheduling of one PDSCH codeword in one cell |
| | and in a random access procedure initialized by a PDCCH |
| | command |
| 1B | Used for brief scheduling of one PDSCH codeword in one cell |
| | using precoding information |
| 1C | Used for brief scheduling of one PDSCH codeword and noti- |
| | fying change in MCCH |
| 1D | Used for brief scheduling of one PDSCH codeword in one cell |
| | including power offset information and precoding |
| 2 | Used for PDSCH scheduling for UE configured in space multi- |
| | plexing mode |
| 2A | Used for PDSCH scheduling of UE configured in large-delay |
| | CCD mode |
| 2C | Used in transmission mode 9 (multi-layer transmission) |
| 3 | Used for transmission of TPC command for PUCCH and |
| | PUSCH including two-bit power adjustment |
| 3A | Used for transmission of TPC command for PUCCH and |
| | PUSCH including single bit power adjustment |
| 4 | Used for scheduling PUSCH in one uplink cell using multi- |
| | antenna port transmission mode |

DCI format 0 denotes uplink resource allocation information, DCI formats 1 to 2 denote downlink resource allocation information, and DCI formats 3 and 3A denote uplink transmit power control (TPC) commands for any UE groups. Each field of the DCI is sequentially mapped to an information bit. For example, when the DCI is mapped to an information bit having a total of 44 bits, the resource allocation information may be mapped to a tenth bit through a 23^{rd} bit of the information bit.

The DCI includes uplink resource allocation information and downlink resource allocation information. The uplink resource allocation information may also be called an uplink grant, and the downlink resource allocation information may also be called a downlink grant.

Table 2 shows format 0 DCI that is uplink resource allocation information (or uplink grant):

TABLE 2
Carrier indicator - 0 or 3 bits
Flag for identifying format 0/format 1A - one bit. 0 denotes format 0 and 1
denotes format 1A.
Frequency hopping flag - one bit. A most significant bit (MSB) correspond-
ing to resource allocation, as necessary. Used for allocation of a multi-
cluster.
Resource block allocation and hopping resource allocation -
┌log₂(N_{RB}^{UL}(N_{RB}^{UL} + 1)/2)┐ bit
PUSCH hopping (corresponding to single cluster allocation only):
N_{UL}_{_{—}}ₕₒₚ most significant bits are used for obtaining ñ_{PRB}(i)
(┌log₂(N_{RB}^{UL}(N_{RB}^{UL} + 1)/2)┐ − N_{UL}_{_{—}}ₕₒₚ) bits provide resource allocation
of a first slot in an uplink sub-frame.
In single cluster allocation, non-hopping PUSCH
(┌log₂(N_{RB}^{UL}(N_{RB}^{UL} + 1)/2)┐) bits provide resource allocation of an uplink
sub-frame.
In multi-cluster allocation, non-hopping PUSCH: resource allocation is
obtained from a combination of a frequency hopping flag field and a
resource block allocation and hopping resource allocation field.
$⌈ {log}_{2} ( ( \begin{matrix}⌈ {N}_{RB}^{UL} / P + 1 ⌉ \\ 4\end{matrix} ) ) ⌉$
bits provide resource allocation in an uplink sub-frame. Here, P
depends on the number of downlink resource blocks.
Modulation and coding scheme/redundancy version - five bits
New data indicator - one bit
TPC command for scheduled PUSCH - two bits
Orthogonal code (OCC) index and cyclic shift for DM RS - three bits
Uplink index - two bits. Existent only for operation of uplink-downlink
configuration 0 TDD
Downlink allocation index (downlink assignment index: DAI) - two bits.
Existent only for operation of uplink-downlink configuration 1-6 TDDs
CQI request - one or two bits. Two bits apply to a UE constituted for at least
one downlink cell.
SRS request - 0 or 1 bit.
multi-cluster flag - one bit

The flag (flag for format 0/format 1A differentiation) is one bit information and is an indicator for distinguishing DCI 0 from DCI 1A. The hopping flag is one bit information and indicates when frequency hopping applies or not when the UE performs uplink transmission. For example, if the hopping flag is 1, this indicates that frequency hopping applies upon uplink transmission, and if the hopping flag is 0, this indicates that no frequency hopping applies upon uplink transmission.

The resource block (RB) allocation and hopping resource allocation is also referred to as a resource allocation field. The resource allocation field indicates the physical location or amount of resources allocated to the UE.

Although not shown in Table 2 above, the uplink grant may include redundant bits or padding bits for keeping the entire number of bits constant so that the uplink grant has the same size as the downlink grant. That is, the DCI has various formats, and the redundant bits may be used so that control information, despite having different formats, has the same bit length, thereby allowing the UE to smoothly perform blind decoding.

For example, if the resource allocation field in a band of FDD 20 MHz has 13 bits is in Table 2 above, the uplink grant (DCI format 0) has a total of 27 bits (excluding the CIF field and CRC field). If the bit length determined for input of blind decoding is 28 bits, the base station adds a one-bit redundant bit to the uplink grant, thus ending up the total number of bits of the uplink grant being 28 bits. By such procedure, DCI format 0 is made to have the same length as DCI format 1A. This is why during the blind decoding procedure DCI format 0 has the same size as DCI format 1A and is thus processed in a single decoding process. Here, since the redundant bits do not contain special information, each redundant bit may be set as 0. Of course, the number of redundant bits may be more or less than 2.

In connection with resource allocation, the structure of physical resources is first described.

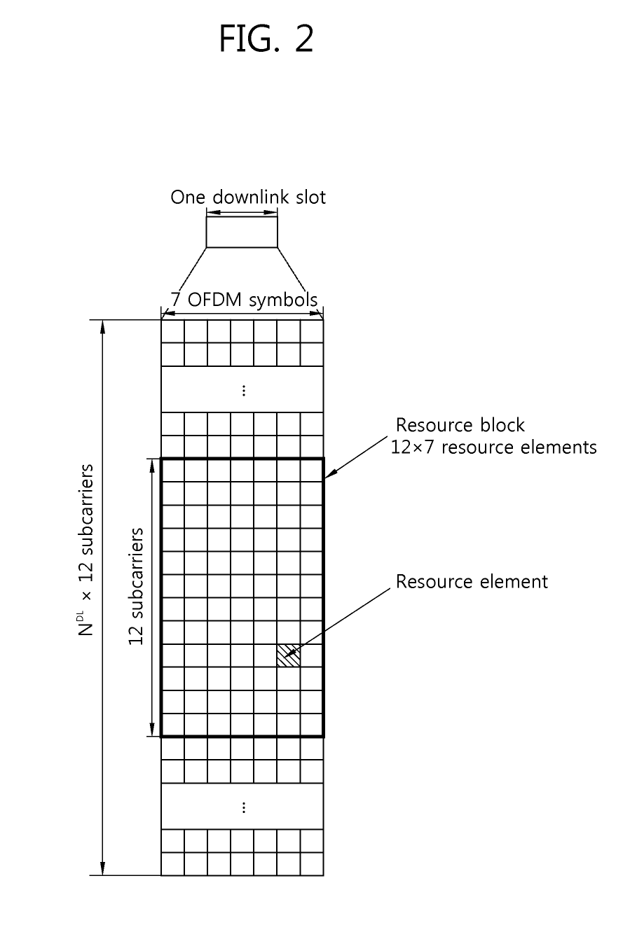

FIG. 2 is a view illustrating an example of a resource grid for one downlink slot to which the present invention applies.

Referring to FIG. 2, each element in the resource grid is referred to as a resource element (RE), and one resource block includes 12×7=84 resource elements. The number N^{DL} of resource blocks included in the downlink slot is dependent upon a downlink transmission bandwidth set in the cell.

A resource region is constituted on a time-frequency basis of resource blocks. In the case of broadband transmission, as the number of resource blocks increases, the number of to bits demanded for representing resource allocation information may increase. Accordingly, a few resource blocks may be combined to be processed in a resource block group (RBG).

The resource allocation information that is represented in a resource block or a resource block group may be transmitted in a resource allocation field in the PDDCH as described above. Here, the resource allocation information may be transmitted in the form of a is resource indication value (RIV).

Bandwidths considered in LTE are 1.4 MHz, 3 MHz, 5 MHz, 10 MHz, 15 MHz, and 20 MHz, and the number of resource blocks corresponding to each band, size of each resource block group (the number of resource blocks constituting one resource block group), and the number of resource block groups are shown in Table 3:

TABLE 3

| | | | Number of resource | |
|---|---|---|---|---|
| | | Total number | blocks included | Total number |
| | | of resource | in one resource | of resource |
| Bandwidth | | blocks | block group | block groups |
| 1.4 | MHz | 6 | 1 | 6 |
| 3 | MHz | 15 | 2 | 8 |
| 5 | MHz | 25 | 2 | 13 |
| 10 | MHz | 50 | 3 | 17 |
| 15 | MHz | 75 | 4 | 19 |
| 20 | MHz | 100 | 4 | 25 |

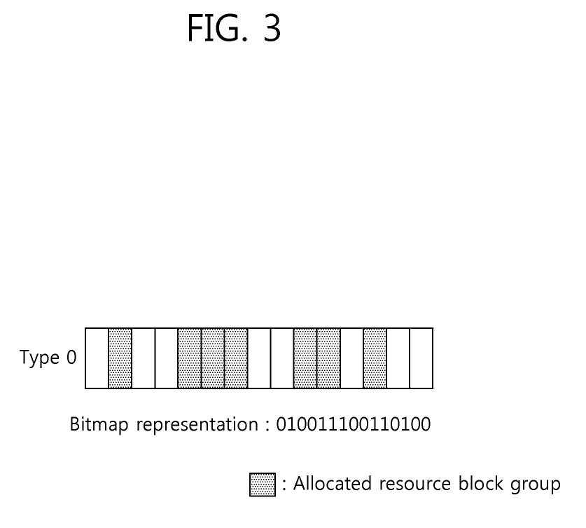

Referring to FIG. 3, the total number of resource blocks usable varies depending on each given bandwidth. The “total number of resource blocks varies” means that the size of information indicating resource allocation changes. Besides, the number of cases in which resource blocks are allocated may differ depending on the resource allocation scheme. As an example of the resource allocation scheme, a resource block group may be allocated using a bitmap format (type 0). As another example of resource allocation, a resource block group may be allocated based on a predetermined interval or period on the frequency axis (type 1). As still another example of resource allocation, a resource block may be allocated on the basis of a region defined by contiguous resource blocks on the frequency axis (type 2). A resource block or resource block group to be allocated to the UE is indicated by the resource allocation field, and the number of bits demanded of the resource allocation field differs depending on the resource allocation scheme of each type and depending on the total number of resource blocks per bandwidth.

Meanwhile, the following three types (type 0, type 1, and type 2) may be used as is resource allocation schemes.

FIG. 3 is a view illustrating a type 0 resource allocation scheme as an example of a resource allocation scheme.

Referring to FIG. 3, a resource is allocated on a per-type 0 resource block basis.

Allocation or non-allocation of each resource block group may be represented in a bitmap, and each bit is mapped with each resource block group. For example, if a bit is 1, this means that the corresponding resource block group may be allocated to the UE, and if the bit is 0, this means that the corresponding resource block group would not be allocated to the UE. Accordingly, a bitmap that represents the example illustrated in FIG. 3 is 010011100110100.

In case resource allocation to the UE is represented in a bitmap type like type 0, the number of bits needed is the same as the number of resource block groups. That is, the to number B of bits may be obtained from Equation 1 in case the number of resource block groups is n and the size of each resource block group (the number of resource blocks of each resource block group) is P:

$$B = ⌈ \frac{n}{P} ⌉ \qquad [ Equation 1 ]$$

Here, ┌x┐ is an integer that is closest to x and is more than x.

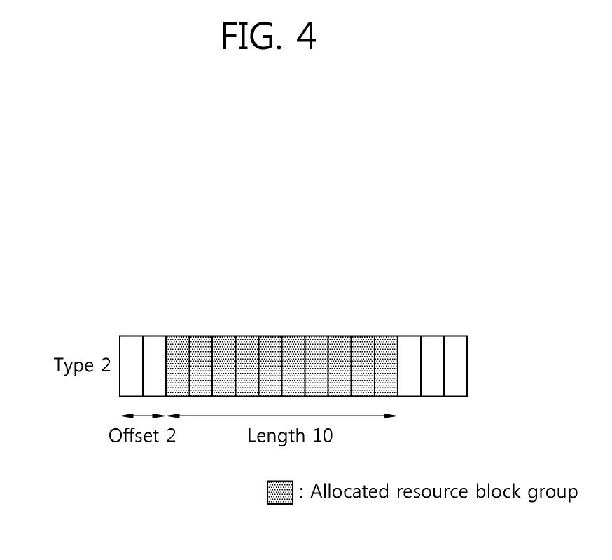

FIG. 4 is a view schematically illustrating a type 2 resource allocation scheme as another example of a resource allocation scheme to which the present invention applies.

Referring to FIG. 4, in type 2, at least one adjacent resource block may be allocated, bundled together. Resource allocation information by type 2 may be represented as an offset of start points of all of the resource blocks and the number of adjacent resource blocks. For example, in the case of FIG. 4, the offset is 2, and the number of resource blocks is 10.

While types 0 and 1 indicate non-contiguous resource allocation, type 2 indicates contiguous resource allocation. Accordingly, in the type 0 or type 1 resource allocation scheme, in many cases, resources to be allocated are represented in a resource block group whereas the type 2 resource allocation scheme represents a resource in the form of resource blocks so that it may have a finer scheduling basis.

When the number of resource blocks increases, the number of bits in the resource allocation field necessary to represent type 2 resource allocation is small as compared with type 0 or 1. In case n resource blocks are allocated by type 2, the number B of bits of the resource allocation field needed may be determined in Equation 2:

$$B = ⌈ {log}_{2} ( \frac{n ( n + 1 )}{2} ) ⌉ \qquad [ Equation 2 ]$$

Meanwhile, in case resource allocation is achieved as described above, a differentiation bit for verifying whether resource allocation applied to a system is contiguous or non-contiguous is needed. In DCI format 0, a remaining redundant bit may be used as the differentiation bit. The redundant bits originate from the fact that DCI format 0 has the same PDCCH size as DCI format 1A. DCI format 0 and DCI format 1A are designed to have the same size, and considering the purpose of each internal field of DCI format 0 and DCI format 1A, DCI format 1A requires one more bit as compared with DCI format 0. Thus, DCI format 0 has always one or more redundant bits. In the blind decoding process, DCI format 0 and DCI format 1A are treated as having the same decoding process and blind decoding is performed assuming a predetermined size per bandwidth. After the predetermined size is verified, a differentiation bit (for differentiating DCI format 0 and DCI format 1A) in the PDCCH is used to identify whether it is DCI format 0 or DCI format 1A.

The cluster means a bundle of contiguous resource blocks or resource block groups.

Meanwhile, in the case of uplink resource allocation, a limited number of clusters, for example, one or two clusters only may be considered. Considering resource allocation of uplink, uplink resource allocation type 0 is of a single cluster type like downlink type 2, and uplink resource allocation type 1 is restricted to have a predetermined number (e.g., two) clusters using enumerative source coding to be described later.

Enumerative source coding may be used to code and decode an RIV for non-contiguous resource allocation using a limited number of clusters. In given resource block indexes 1 to N, for M clusters {sₖ}_{K=0}^{M-1} (1<sₖ<N, sₖ<sₖ₊₁) sorted in ascending order, the following value may be calculated:

$$r = {\sum }_{k = 0}^{M - 1} 〈 \begin{matrix}N - {s}_{k} \\ M - k\end{matrix} 〉 \\ Here , \\ 〈 \begin{matrix}x \\ y\end{matrix} 〉 = \{ \begin{matrix}( \begin{matrix}x \\ y\end{matrix} ) & x \geq y \\ 0 & x \geq y ,\end{matrix} \\ and \\ ( \begin{matrix}x \\ y\end{matrix} ) means {}_{x}^{}{C}{}_{y}^{} . \\ Here , \\ r ∈ \{ 0 , … , ( \begin{matrix}N \\ M\end{matrix} ) - 1 \} . \qquad [ Equation 3 ]$$

Under the condition in which the resource blocks have indexing formats from 1 to N (N^{UL}_{RB} is the number of uplink resource blocks), the start value of each cluster uses, as is, the index value of a resource block, and the end value of each cluster is designated in the form of index value+1 of a resource block and is coded in the enumerative source form.

Here, the UE may conduct enumerative source coding by the algorithm shown in Table 4:

TABLE 4

```
xₘᵢₙ = 1
for k = 0 to M − 1,
x = xₘᵢₙ
$p = 〈 \begin{matrix}N - x \\ M - k\end{matrix} 〉$
while p > r,
  x = x + 1
  $p = 〈 \begin{matrix}N - x \\ M - k\end{matrix} 〉$
end
sₖ = x
xₘᵢₙ = sₖ + 1
r = r − p
end
```

Meanwhile, LTE-A supports carrier aggregation. Carrier aggregation configures a carrier by combining a plurality of bands for downlink and uplink in FDD and expands an existing single band or carrier allocated to both uplink and downlink in TDD. Communication quality and channel capacity may be increased by carrier aggregation.

In carrier aggregation, a critical standard for design is to maximally utilize the standards for a single carrier supported in the existing LTE standards. The existing LTE standards have standards for carriers having various bandwidths and designing an individual carrier in carrier aggregation, in principle, follows as many existing LTE standards as possible. In carrier aggregation, the maximum number of carriers that may be allocated to the UE varies from UE to UE. A set of a maximum number of carriers that may be allocated to the UE may be defined as a configuration component carrier set.

In carrier aggregation, an existing standard constituted of a single component carrier may be expanded to multiple component carriers, and here, cross carrier scheduling is possible that allows a component carrier to schedule another component carrier.

Component carriers may be separated into primary component carriers (PCCs) and secondary component carriers (SCCs) depending on whether they are activated. Primary component carriers are carriers that remain activated all the time, and secondary component carriers are carriers that are activated or deactivated depending on specific conditions. Activation means that traffic data is being or ready to be transmitted or received. Deactivation means that transmission or reception of traffic data is impossible and measurement or transmission/reception of a minimum amount of information is possible. Activation/deactivation is done in a scheme in which an SIB-2-linked uplink control channel comes after an activated/deactivated state of downlink with respect to a downlink component carrier. No scheduling is achieved on the deactivated downlink component carrier nor is CSI measured by the UE. In contrast, PDSCH allocation is done on an activated downlink component carrier, and CSI measurement thereon is performed by the UE and is thus reported to the base station. An activation/deactivation scheme applies in order to reduce complexity of the UE and power demanded. Activation/deactivation is determined by the base station. The UE is controlled by MAC signaling of the base station, and ambiguity may be present between the base station and the UE for a configuration time or signaling delay or by an MAC signaling error.

The UE uses only one primary component carrier or may use one or more secondary component carriers in addition to the primary component carrier. The UE may be assigned a primary component carrier and/or secondary component carrier from the base station.

In carrier aggregation, a PDCCH may transmit allocation information not only for resource allocation in the component carrier to which the PDCCH belongs, but also for resources of another component carrier. This is referred to as cross-carrier scheduling. Control information regarding a secondary component carrier may be transferred to a primary component carrier through cross-carrier scheduling, thus leading the scheduling to be flexible. Cross-carrier scheduling may be implemented by a carrier indicator field (CIF). The CIF is included in the payload of a PDCCH. The CIF is an individual field indicating at least one component carrier that is allocated to a specific UE. In cross-carrier scheduling, the UE may identify through the CIF which component carrier the received control information on the PDCCH is for. Presently, in LTE-A, a three-bit field is allocated to the CIF to indicate up to five component carriers. That is, among possible values 0 to 7, only five values are actually used to indicate component carriers and the remaining three values are not used but remain reserved.

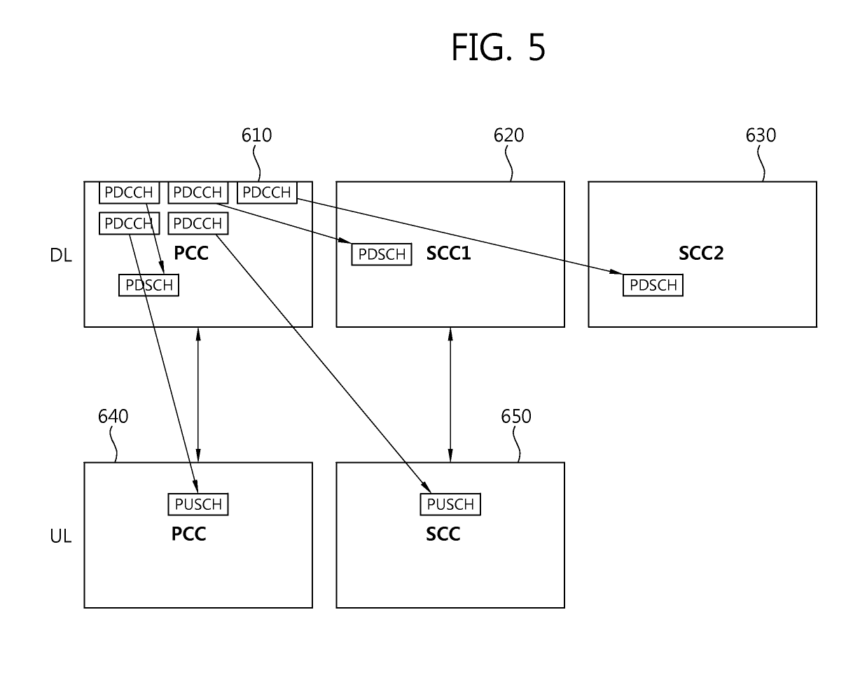

FIG. 5 is a view schematically illustrating an example of cross-carrier scheduling in carrier aggregation.

Referring to FIG. 5, the downlink primary component carrier 610 is a single carrier but may be assigned both a downlink grant and an uplink grant for a secondary component carrier by cross-carrier scheduling. In FIG. 5, the PDCCH of the downlink primary component carrier 610 schedules transmission of the PUSCHs of uplink component carriers 640 and 650 and PDSCHs of downlink secondary component carriers 620 and 630.

The uplink primary component carrier 640—although it is a single component carrier, a resource for a PUCCH is properly allocated (explicit allocation or implicit allocation)—may be assigned a PUCCH for a downlink component carrier. Here, the “explicit resource allocation” means when resource allocation is explicitly notified to the UE through upper level signaling, and the “implicit resource allocation” means when resource allocation is informed to the UE through a proper rule including, e.g., the position of the PDCCH in the control region. The physical uplink control channel (PUCCH) is a channel for delivering control information on uplink and means a channel for delivering UCI (Uplink Control Information) such as ACK/NAK, CQI/PMI/RI.

Meanwhile, aperiodic CSI (Channel State Information) report payload may be basically determined depending on a report mode for a ‘configured component carrier’ and the number of configured component carriers.

Specifically, if carrier aggregation is configured, an aperiodic CSI request field includes two bits (one bit is added to the DCI format in a UE-specific search space). ‘00’ denotes that the CSI has not been triggered yet, ‘01’ denotes that a downlink component carrier SIB-2-linked to the uplink component carrier for transmitting a CSI report has been triggered, and what are denoted by ‘10’ and ‘11’ may be configured by an RRC.

In the common search space, ‘0’ denotes that the CSI has not been triggered yet, and what is denoted by ‘1’ may be configured by an RRC. The RRC may configure any carrier aggregation combination for up to five component carriers.

Here, ‘10’ or ‘11’ may be an indication for a subset of ‘configured component carriers’ by RRC signaling and this may be recognized by the base station and the UE by PDCCH signaling. PDCCH signaling may apply to a subset of ‘configured component carriers’ that are restricted by ‘10’ or ‘11.’ In such case, the size of payload is previously determined by an RRC, not an entire set of configured component carriers, and may also be determined depending on a subset of ‘configured component carriers’ that are triggered by a PDCCH.

Further, as in the case of ‘01,’ downlink component carriers determined by SIB-2 linkage—although the number of the downlink component carriers is only one—may be deemed one of subsets of ‘configured component carriers.’ That is, in such case, reporting is performed to comply with the reporting mode given for the SIB-2-linked downlink component carrier, and (although the number of ‘configured component carriers’ is more than 1) the number of component carriers is deemed to be one, when applying what is described above.

Meanwhile, each SIB (System Information Block) includes different system information, and information necessary for the UE to access a cell and link information between a downlink component carrier and an uplink component carrier are indicated by SIB-2.

In the example illustrated in FIG. 5, the downlink primary component carrier 610 has linkage with the uplink primary component carrier 640, and the downlink secondary component carrier 620 has linkage with the uplink secondary component carrier 650. No uplink component carrier has linkage with the downlink secondary component carrier 630. The linkage between the downlink component carrier and the uplink component carrier may be indicated by SIB-2. A linkage setting between the uplink component carrier and the downlink component carrier may be done cell-specifically or UE-specifically (UE-specifically). Upon CQI triggering of an allocated uplink grant or when a CQI request bit is set, CSI for the lined downlink component carrier, for example, CQI/PMI (Precoding Matrix Indicator)/RI (Rank Indicator), is transmitted.

As compared with the above-described cross-carrier scheduling, when no cross-carrier scheduling is done, the control channel of a downlink component carrier delivers only the control information for its linked uplink component carrier.

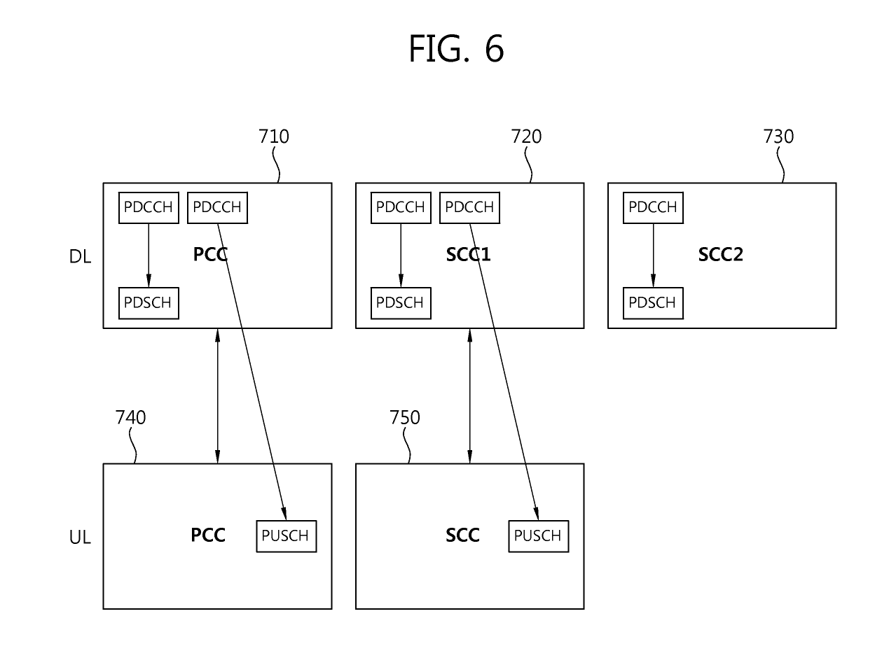

FIG. 6 is a view schematically illustrating an example in which no cross-carrier scheduling is done in carrier aggregation.

Referring to FIG. 6, the downlink primary component carrier PCC, 710 is linked to the uplink primary component carrier PCC, 740, and the downlink first secondary component carrier SCC1, 720 is linked to the uplink secondary component carrier SCC, 750. Here, the PDCCH of the downlink primary component carrier 710 delivers control information for the uplink primary component carrier 740, and the downlink first secondary component carrier 720 is delivers control information for the uplink secondary component carrier 750.

In case no cross-carrier scheduling is done as in FIG. 6, CIF may be scheduled unnecessarily, and this is represented as a self-scheduling mode. On the contrary, in case cross-carrier scheduling is done, this is referred to as a cross-carrier scheduling mode and in this case, CIF is inevitably required.

In carrier aggregation, an extension carrier may be defined. A carrier which is not an extension carrier is commonly called a component carrier. The extension carrier does not include a control region, and the existing PDCCH is not transmitted over the carrier. Further, if not having a CRS (Common Reference Signal) or if having a lower ratio than that of a common component carrier, the extension carrier is configured based on a DM RS (Demodulation Reference Signal).

As scheduling for an extension carrier region, cross-carrier scheduling is basically considered.

Application of an extended or enhanced PDCCH present in the existing PDSCH region over two slots in a sub-frame over time for the extension carrier is being considered as well.

The enhanced PDCCH is considered to be applied to a common component carrier, as well as to an extension carrier, and in such case, the control region portion that is a front portion on the time axis is excluded from the region of the enhanced PDCCH.

Activation/deactivation of a component carrier applies to carrier aggregation.

Meanwhile, in a carrier aggregation environment, it may be considered to dynamically transmit variable resource allocation information for an individual component carrier or a plurality of component carriers through one PDCCH. Here, in case resource allocation information for each component carrier is individually designated by the base station, a value systemically defined may be used. The “concatenation” logically refers to the concatenation between component carriers, and physical locations on the frequency axis might not be concatenated to each other.

Hereinafter, dynamically delivering resource allocation information for component carriers through one PDCCH by the base station in a carrier aggregation environment is described. Here, for ease of description, information on the size of a resource block group for a component carrier is an example of resource allocation information.

In a system according to the present invention, the base station may dynamically vary, UE-specifically, the size of a resource block group (RBG) in a resource allocation field of a PDCCH. That is, the base station may the size (P) of a resource block group scheduled UE-specifically and deliver it to the UE through the resource allocation field of the PDCCH.

Resource blocks or resource block groups may configure resource block groups per component carrier and the configured resource block groups may be allocated to the UE. Even for the resource blocks allocated per component carrier, resource blocks and resource block groups allocated for a plurality of component carriers may be concatenated to form a single resource block group. Here, the base station may schedule the connected resource block groups as resources allocated to the UE and may deliver the size of the scheduled resource block group to the UE through one PDCCH.

For example, in a carrier aggregation environment constituted of component carriers, in the case of a component carrier having a band of 20 MHz, one resource block group (RBG) may consist of four resource blocks. Here, the base station may perform scheduling and signaling on each component carrier so that for two 20 MHz-band component carriers, the size of a resource block group allocated is 4 or may conduct scheduling and signaling on the two component carriers so that the size of a resource block group allocated is 8. Here, the base station may dynamically carry out this operation.

In case resource allocation is performed on all of the two component carriers, that is, in case the size of the resource block group is 8, scheduling may be coarse, but it enables scheduling to be done on two component carriers through one PDCCH, thereby allowing the resource allocation field of the PDCCH to be efficiently utilized.

Hereinafter, for ease of description, component carriers configured so that, among component carrier groups, individual component carriers are concatenated and scheduled are referred to as a component carrier sub group. Scheduling on a component carrier sub group may be done by one PDCCH. The base station may allocate resources to all the component carriers constituting the component carrier sub group or may perform scheduling on a resource block group basis that is newly configured by concatenating resource blocks or resource block groups allocated in the case of an individual component carrier.

Hereinafter, for ease of description, a resource block group for a new resource space which is configured by concatenating resource blocks or resource block groups allocated to individual component carriers of a component carrier sub group is referred to as a “resource block group for a sub group.”

The size of a resource block group for a sub group, as described to be later, may be determined by an upper layer or may be determined considering the configuration of a component carrier, and is transmitted to the UE through the resource allocation field of a PDCCH.

Here, the component carriers constituting a component carrier group may have the same or different transmission modes. In case the component carriers have the same transmission mode, common control information and/or transmission information may be transmitted through the control region of the PDCCH except the resource allocation field.

In order to transmit the size of a resource block group between the base station and the UE, a specific size information set may be determined for the UE by upper layer signaling. When receiving the size information set by the upper layer signaling of the base station, the UE may verify the size of a resource block group corresponding to information transmitted through the resource allocation field of the PDCCH from the size information set.

In case the component carrier bands of the component carrier group are all the same, the size information set may be configured of set configuration elements having, as their basis, the size of a resource block group basically determined in the system. For example, in the case of LTE, if the size P of a resource block group basically assumed is 4, the size information set may be configured so that the set configuration element (size of the resource block group) is a multiple of 4.

In case the component carriers of a component carrier group do not have the same band, the size information set may be configured of set configuration elements that do not have, as their basis, the size of a resource block group basically set in the system. For example, in the case of LTE, even though the size P of a resource block group basically assumed is 4, the set configuration elements of the size information set, that is, the sizes of the resource block group might not be a multiple of 4.

When configuring a size information set, the base station may configure the size information set by determining the size of the resource block group for component carrier sub groups. A component carrier group may be obtained from among all the configured component carriers or may be obtained only from activated component carriers. Here, the “configured component carriers” mean component carriers determined to be semi-statically used by upper layer signaling, and “activated component carriers” mean component carriers that are determined further dynamically by MAC signaling and that PDCCH information is to be blind decoded only for.

Meanwhile, the size information set may be a size information table consisting of a component carrier sub group that may be constituted of component carriers of a component carrier group, a code point corresponding to the component carrier sub group and/or size of a resource block group for each component carrier sub group.

A method of determining the size of a resource block group for a component carrier sub group is now described. An example of a resource block group for a component carrier sub group is when the size of a resource block group is 8 as described above. In such a case, a component carrier sub group may be considered to be constituted of two 20 MH band component carriers.

As another simple example, a component carrier group may be considered which consists of component carrier 0 having a 20 MHz band, component carrier 1 having a 10 MHz band, and component carrier 2 having a 10 MHz band.

(Case 1) sub group of component carrier 0 and component carrier 1—the size P1 of to a resource block group for the sub group of component carrier 0 and component carrier 1 may be determined as 6.

(Case 2) sub group of component carrier 1 and component carrier 2—the size P2 of a resource block group for the sub group of component carrier 1 and component carrier 2 may be determined as 4.

Here, the size of a resource block group for a component carrier sub group may be determined in an upper layer, and the size information set consisting of resource block group sizes P may be transferred to the UE through upper layer signaling.

Meanwhile, the size of a resource block group for a component carrier sub group may also be determined based on the configuration of the component carrier group. In case the size of a resource block group for a component carrier sub group is determined based on the configuration of a component carrier group, for example, Equation 4 below may be used.

P=number of resource blocks for all component carriers in component carrier sub group/number of resource block groups for predetermined reference component carrier

In case the size P of a resource block group is not an integer, the size P of a resource block group may be determined by operation ┌P┐. When A<P<=A+1(A is an integer), ┌P┐ may be determined as A+1.

Here, “all the component carriers” in the component carrier sub group may be all the “configured component carriers” in the component carrier sub group or all the “activated component carriers.” Here, whether “all the component carriers” in the component carrier sub group are all the “configured component carriers” or all the “activated component carriers” may be previously determined between the base station and the UE and may be delivered to the UE through upper layer signaling.

Further, the “reference component carrier” may be a component carrier having the maximum band in the component carrier group, a component carrier having a predetermined band, a component carrier through which a PDCCH is transmitted, or a component carrier indicated by a PDCCH (indicated by the PDCCH as the position of a PDSCH or PUSCH). Whether the “reference component carrier” is determined as the component carrier having the maximum band in the component carrier group, the component carrier having a predetermined band, the component carrier through which a PDCCH is transmitted, or the component carrier indicated by a PDCCH (indicated by the PDCCH as the position of a PDSCH or PUSCH) may be previously determined between the base station and the UE and may be delivered to the UE through upper layer signaling.

As an example of determining the size P of a resource block group for a component carrier sub group by using Equation 4, the above-described component carrier group consisting of component carrier 0 having a 20 MHz band, component carrier 1 having a 10 MHz band, and component carrier 2 having a 10 MHz band is described.

(1) In Case the Component Carrier Having the Maximum Band is Determined as the Reference Component Carrier

In this case, in the above-described case 1, the component carrier having the maximum band for the sub group of component carrier 0 having a 20 MHz band and component carrier 1 having a 10 MHz band is component carrier 0. Referring to Table 3, the number of resource blocks in the sub group of component carrier 0 and component carrier 1 is 150 (component carrier 0: 100, component carrier 1: 50), and the number of resource block groups of component carrier 0 is 25. Accordingly, the size P1 of a resource block group for a component carrier sub group is 6.

Further, in the above-described case 2, since component carrier 1 and component carrier 2 both have the same 10 MHz band, the component carrier having the maximum band is either component carrier 1 or component carrier 2. Referring to Table 3, the number of resource blocks in the sub group of component carrier 1 and component carrier 2 is 100 (component carrier 1: 50, component carrier 2: 50), and the number of resource block groups of is component carrier 1 or component carrier 2 is 17. Accordingly, the size P2 of a resource block group for a sub group is 6.

(2) In Case the Component Carrier Having a Specific Band is Determined as the Reference Component Carrier

Assume that the predetermined band is 10 MHz. Accordingly, in the instance, the reference component carrier is either component carrier 1 or component carrier 2.

Referring to Table 3 for case 1, the number of resource blocks in the sub group of component carrier 0 and component carrier 1 is 150 (component carrier 0: 100, component carrier 1: 50), and the number of resource block groups of component carrier 1 is 17.

Accordingly, the size P1 of a resource block group is 10 according to Equation 4.

Further, referring to Table 3 regarding the above-described case 2, the number of resource blocks in the sub group of component carrier 1 and component carrier 2 is 100 (component carrier 1: 50, component carrier 2: 50), and the number of resource block groups of component carrier 1 and component carrier 2 is 17. Accordingly, the size P2 of a resource block group is 6 according to Equation 4.

(3) In Case the Component Carrier Through which PDCCH is Transmitted is Determined as the Reference Component Carrier

In Equation 4, a component carrier where a control channel region (PDCCH) is present may be rendered to be used as the ‘reference component carrier.’ For example, in case a PDCCH is present only in a primary component carrier, the size P of a combined resource block group may be determined based on the band of the primary component carrier.

For convenience of description, assume that component carrier 1 is the component carrier where a PDCCH is transmitted. In such case, referring to Table 3 for case 1, is the number of resource blocks in the sub group of component carrier 0 and component carrier 1 is 150 (component carrier 0: 100, component carrier 1: 50), and the number of resource block groups of component carrier 1 is 17. Accordingly, the size P1 of a resource block group for a sub group is 9.

Further, referring to Table 3 for case 2, the number of resource blocks in the sub group of component carrier 1 and component carrier 2 is 100 (component carrier 1: 50, component carrier 2: 50), and the number of resource block groups of component carrier 1 is 17. Accordingly, the size P2 of a resource block group for a sub group is 6.

(4) In Case the Component Carrier Indicated by a PDCCH (Component Carrier Indicated by the PDCCH as the Position of a PDSCH or PUSCH) is Determined as the Reference Component Carrier

In Equation 4, a component carrier indicated as the position of a PDSCH or PUSCH by a control channel region (PDCCH) may be rendered to be used as the ‘reference component carrier.’

For ease of description, assume that the component carrier indicated by the PDCCH as the PDSCH being positioned is component carrier 1 .

In such case, referring to Table 3 for case 1, the number of resource blocks in the sub group of component carrier 0 and component carrier 1 is 150 (component carrier 0: 100, component carrier 1: 50), and the number of resource block groups of component carrier 1 is 17. Accordingly, the size P1 of a resource block group for a sub group is 9.

Further, referring to Table 3 for case 2, the number of resource blocks in the sub group of component carrier 1 and component carrier 2 is 100 (component carrier 1: 50, component carrier 2: 50), and the number of resource block groups of component carrier 1 is 17. Thus, the size P2 of a resource block group for a sub group is 6.

As such, when configuring a size information set, the size of a resource block group is determined on a component carrier sub group possible for component carriers constituting a component carrier group, and resource allocation is performed on a per-determined resource block group basis. By doing so, allocated resource regions are logically connected in series with each other, thus expanding a resource allocation region.

Although P may be determined using Equation 4, P may be arbitrarily determined on each component carrier sub group. The configuration of a sub group is notified from the base station to the UE through upper layer signaling (for example, MAC or RRC signaling). Like in the example of the configuration of the component carrier sub group, the configuration of a P value arbitrarily set is previously notified from the base station to the UE as a value linked to each component carrier sub group by upper layer signaling (for example, MAC or RRC signaling).

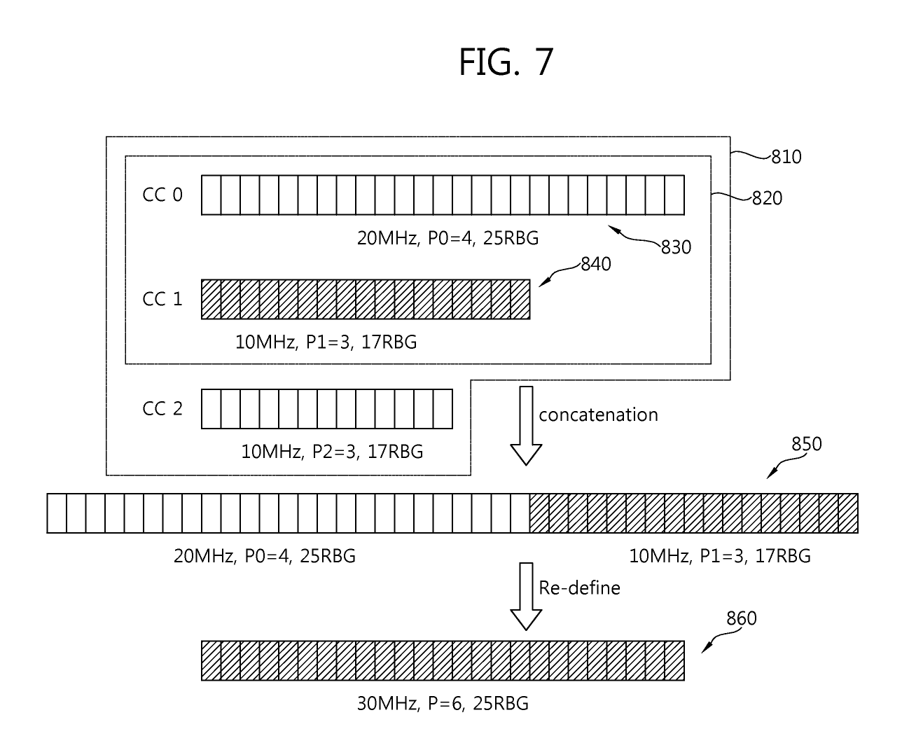

FIG. 7 is a view schematically illustrating a method of varying the size of a resource block group, that is, a method of configuring a resource block group for a component carrier sub group in a system to which the present invention applies.

FIG. 7 illustrates an example in which in a component carrier group 810 constituted of configured component carrier 0 CC0, component carrier 1 CC1, and component carrier 2 CC2, a component carrier sub group 820 is constituted of component carrier 0 and component carrier 1, and the size P of a resource block group for a resource region 850 allocated for the component carrier sub group 820 is determined.

As shown in FIG. 7, assume that component carrier 0 has a band of 20 MHz, and the resource block group size P0 for a resource region 830 allocated to component carrier 0 is 4, and the number of resource block groups is 25. Further, assume that component carrier 1 has a band of 10 MHz, the size P1 of a resource block group for a resource region 840 allocated to component carrier 1 is 3, and the number of resource block groups is 17.

Here, the size P of a resource block group for the component carrier sub group 820 is determined using Equation 4. For ease of description, a component carrier having the maximum band is defined as the reference component carrier.

Accordingly, in the case of determining the size of a resource block group for the sub group 820 of component carrier 0 and component carrier 1, when the two component carriers are connected in series to each other, a resultant band is 30 MHz, and the size P of a resource block group for the component carrier sub group 820, when Equation 4 is used, is calculated as in Equation 5:

$$\begin{matrix}P = \frac{\begin{matrix}total number of resource blocks for \\ component carrier 0 and component carrier 1\end{matrix}}{\begin{matrix}number of resource block groups for reference \\ component carrier ( component carrier 0 )\end{matrix}} \\ = \frac{100 \cdot 50}{25} \\ = 6\end{matrix} \qquad [ Equation 5 ]$$

Since the number of all of the resource blocks is 150, and the number of resource block groups for the reference component carrier (component carrier 0) for the component carrier sub group 820 is 25, the size P of a resource block group (the number of resource blocks per resource block group) is 6.

Meanwhile, unlike above, the size P of a resource block group may be transmitted independently from a resource block group of the reference component carrier. That is, a set of resource block group sizes P is delivered in advance from the base station to the UE through upper layer signaling, and in this set, a specific resource block group size P may be dynamically allocated by a PDCCH. In such case, a resource block or resource block group may begin from a component carrier where a PDCCH is present or a component carrier indicated by the PDCCH.

In such case, the start and end of a resource space newly configured according to the present invention may be specified as follows. The following example may also apply to when a component carrier sub group is defined but P is not determined by Equation 4. Here, if Equation 4 applies to a component carrier sub group, all the resource blocks or all the resource block groups for the component carrier sub group may be configured as a new resource space.

Method of configuring a resource space—a resource allocation region, in case a CIF is present, may be a resource region connected in series according to the order of the CIF. In case a CIF is present, the resource allocation region may be a resource region connected in series in the order of the CIF, beginning from a component carrier designated by the CIF. In case no CIF is present, the resource allocation region may be a resource region connected in series in a cell index order from a cell (component carrier) designated by a PDCCH. The cell index means a number indicating the order between cells (component carriers) specified in the system.

Hereinafter, the end point of the resource allocation region may be determined by the size P of a resource block group. Accordingly, the base station may allocate a resource to the UE by transmitting the size P of a resource block group on the PDCCH. A method of dynamically signaling the size of a resource block group by the base station is described hereinafter. Information on the size of a resource block group dynamically scheduled may be signaled on a PDCCH, and a new field may be added to the PDCCH or an existing field may be utilized. Further, a method of adding a new field to the PDCCH and utilizing the added field together with the existing fields may be also employed. Hereinafter, each method is described.

(1) Method of Adding and Signaling a New Field

A new field with a predetermined number of bits is added to a PDCCH, and the size P of a resource block group may be dynamically delivered to the UE through the field. Here, the size P of a resource block group may have a value in an information set that is previously determined by upper layer signaling between the base station and the UE.

(1-1) In Case the Size of a Resource Block Group is Determined and then Transmitted to the UE

In case a new field to be added has one bit, a code bit may be used to deliver information on two different sizes to the UE. Table 5 shows an example of a size information set that may be used in case one bit is added. Table 5 schematically illustrates a size information table.

TABLE 5

| Code point | Size (P) |
|---|---|
| 0 | 4 |
| 1 | 8 |

Assuming that the UE and the base station use Table 5 in order to deliver the size of a resource block group, if the code point to be delivered is 0, this may denote that the resource block group size P1=4, and if the code point to be delivered is 1, this may denote that the resource block group size P2=8.

In case the added field has two bits, a code bit may be used to deliver information on four different sizes to the UE. Table 6 is a size information table schematically showing an example of a size information set that may be used in case two bits are newly added.

TABLE 6

| Code point | Size (P) |
|---|---|
| 00 | 4 |
| 01 | 5 |
| 10 | 6 |
| 11 | 8 |

Assuming that the UE and the base station use Table 6 in order to deliver the size of a resource block group, if the code point to be delivered is 00, this may denote that the is resource block group size P=4, if the code point to be delivered is 01, this may denote that the resource block group size P=5, if the code point to be delivered is 10, this may denote that the resource block group size P=6, and if the code point to be delivered is 11, this may denote that the resource block group size P=8.

(1-2) In Case Size is Determined Based on the Configuration of a Component Carrier Group

The base station delivers only the information on the component carriers constituting a component carrier sub group in a component carrier group to the UE on a PDCCH. The UE may determine, through Equation 4, the size P of a resource block group for a component carrier sub group.

Further, the size of a resource block group for a component carrier sub group, together with information on the component carriers constituting the component carrier sub group, may be delivered to the UE on a PDCCH.

In case one bit is newly added, a code point may be used to deliver information on different sizes. Table 7 is a size information table schematically showing an example of a is size information set that may be used in case one bit is added.

TABLE 7

| Code point | Component carrier sub group | Size (P) |
|---|---|---|
| 0 | Component carrier sub group 0 | P0 |
| 1 | Component carrier sub group 1 | P1 |

In order to deliver the size of a resource block group for a sub group, assume that the UE and the base station use Table 7. In such case, the base station may deliver code point 0 to configure a component carrier sub group of component carriers belonging to component carrier sub group 0 and to indicate the size of a resource block group for the configured sub group is P0. The UE may be allocated a resource block group having a size of P0.

Further, the base station may deliver code point 1 to configure a component carrier sub group of component carriers belonging to component carrier sub group 1 and to indicate the size of a resource block group for the configured sub group is P1. The UE may be allocated a resource block group having a size of P1.

In case the newly added field has two bits, a code point may be used to deliver four different resource block group sizes to the UE. Table 8 is a size information table schematically showing an example of a size information set that may be used in case two bits are newly added.

TABLE 8

| Code point | Component carrier sub group | Size (P) |
|---|---|---|
| 00 | component carrier sub group 0 | P0 |
| 01 | Component carrier sub group 1 | P1 |
| 10 | Component carrier sub group 2 | P2 |
| 11 | Component carrier sub group 3 | P3 |

Assuming that the UE and the base station use Table 8 in order to deliver information on a resource block group size, the base station may deliver a code point to indicate a component carrier sub group and a resource block group size corresponding to the component carrier sub group as shown in Table 8.

The component carrier sub group may consist of a single specific component carrier or a plurality of component carriers or all of the component carriers. In case a component carrier sub group consists of a single specific component carrier, the size P of a corresponding resource block group may be the size of a resource block group having a corresponding band specified in an LTE system.

The size P of a resource block group for a sub group may be directly delivered using a size information set or may be determined using Equation 4 without being specified in a size information set. Whether to use Equation 4 and which component carrier is to be used as the reference component carrier may be delivered through upper layer signaling.

In the above-described examples (1-1) and (1-2), the base station may dynamically determine the size P of a resource block group in the size information set and may deliver it to the UE through a field newly added to the PDCCH.

(2) Method of Signaling Utilizing an Existing Field

In case a field is specified but is not used, the base station may use the bits allocated to the unused field to deliver the size P of a resource block group to the UE as described above.

For example, in case an existing specified field is a CIF, among the code points of the CIF, a code point other than code points for component carriers constituting a component carrier group may be used to deliver the size P of a resource block group.

For example, in the current LTE system in which a component carrier group is constituted of up to five component carriers, among CIF values 0 to 7, values 5 to 7 may be used.

Table 9 is a size information table schematically illustrating an example of a size information set that may be used in case a CIF is utilized as a conventional field for delivering the size of a resource block group.

TABLE 9

| CIF | Component carrier sub group | Size (P) |
|---|---|---|
| 5 | Component carrier sub group 0 | P0 |
| 6 | Component carrier sub group 1 | P1 |
| 7 | Component carrier sub group 2 | P2 |

Assuming that the UE and the base station use Table 9 in order to deliver the size of a resource block group, the base station may indicate a sub group of component carriers and the size of a resource block group corresponding to the sub group as shown in Table 9 by delivering code points 5 to 7 of the CIF.

Component carrier sub groups 0 to 2 may be constituted of a single specific component carrier or a plurality of component carriers or may indicate all of the component carriers.

Sizes P0 to P2 may be directly delivered using a size information set or may be determined using Equation 4 according to a component carrier set. Whether to use Equation 4, and if so, which component carrier is to be used as a reference may be delivered through upper layer signaling.

A size information set, i.e., a setting of a CIF value, may be determined in an upper layer (e.g., an RRC layer) and may be delivered to the UE through upper layer signaling (for example, RRC signaling).

(3) Signaling Method Using Both an Existing Field and a New Field

Signaling may be performed by adding a new field while utilizing an existing field. For example, a new bit is added, and if the added bit is, an existing field may be used as originally intended, and in case the added bit is 1, the existing field may be utilized as a bit for transferring the size P of a resource block group as described above in the ‘(1) Method of adding and signaling a new field.’

An example in which the existing field is a CQI (Channel Quality Indicator) request field is described. The base station may add a new bit to the CQI request field and may transmit it to the UE. In case the new bit is 0, the UE recognizes the CQI request field, as originally intended, as related to a CQI request and may accordingly perform an operation. In case the new bit is 1, the UE may recognize the CQI request field, which has one or two bits, as delivering the size P of a resource block group and may operate accordingly. Of course, the base station may configure information that is transmitted through the CQI request field as indicated by the new bit. For example, in case the new bit is 0, the base station delivers a CQI request message through the CQI request field, and in case the new bit is 1, the base station delivers the size P of a resource block group through the CQI request field.

An example in which a CQI request field is used as the existing field has been described. However, the existing field that may be adopted for a signaling method utilizing both an existing field and a new field is not limited thereto, and a CIF or MCS (Modulation and Coding Scheme) field may also be utilized likewise. In other words, in case the newly added field is 0, a CIF or MCS field is used as originally intended, and in case the newly added field is 1, the bit allocated to the CIF or MCS field may be used for transmitting the size of a resource block group.

The above-described settings regarding a signaling method using an existing field and a new field may be determined in an upper layer (for example, an RRC layer) and delivered to the UE through upper layer signaling (for example, RRC signaling).

The afore-described methods according to the present invention may be expanded to the case of expanded carriers as well. In case an expanded carrier is present and no enhanced PDCCH is used, use of cross-carrier scheduling is the same as what has been described above. In the case of self-scheduling, scheduling on an expanded carrier may be easily configured in a scheme suggested herein. In such case, an order for logically connecting an expanded carrier with other carriers may be determined by upper layer signaling.

An enhanced PDCCH may apply regardless of whether it is an expanded carrier or not, and even when an enhanced PDCCH applies to an existing component carrier and expanded carrier, a scheme according to the present invention may also apply, as applied to the existing PDCCH.

Variably configuring the size of a resource block group in a method of configuring a PDCCH, in particular, in the resource allocation, has been described thus far in light of carrier aggregation. However, the technical spirit of the present invention may be further expanded. For example, the carrier that has been considered according to the present invention may be expanded to the concept of a cell, and accordingly, variable transmission of control information by a single PDCCH, which has been described above, may be applicable to a cell as well. In other words, the size of a resource block group, which is allocated to the UE for multiple cells, may be determined and transmitted through a single PDCCH.

According to the present invention, in case application of the above-described concept of component carrier is expanded to cells, the cells include not only primary serving cells but also ambient cells considered in a CoMP (Coordinated Multi-Point) environment, RRHs (Remote Radio Heads) inside or outside primary cells, and relays that relay between base stations and UEs. A base station of a primary serving cell (primary base station) connects resource block groups allocated to each cell included in the CoMP with each other and may transmit information on the size of the connected resource block groups to a UE on a single PDCCH.

Hereinafter, for ease of description, like the component carrier sub group, among groups of cells included in the CoMP, cells scheduled so that resource block groups allocated to individual cells are connected are referred to as a cell sub group, and with respect to cells of a cell sub group, a resource block group connecting resource block groups allocated to individual cells is referred to as a resource block group for a sub group. For a cell sub group, UE-specific resource allocation may be done by a single PDCCH from a primary base station. A cell sub group may be constituted of a single cell.

In the CoMP environment, the UE may receive signals from multiple cells and a signal transmitted from the UE may also be received by the multiple cells. If such downlink transmission from the multiple cells is coordinated, that is, if downlink transmission is performed from multiple cells geometrically separated from each other, downlink performance may be significantly enhanced.

Downlink CoMP transmission schemes include (1) coordinated scheduling and/or coordinated beamforming and (2) joint processing/joint transmission.

Through the coordinated scheduling and/or coordinated beamforming, cell selection of transmitting data to the UE may be dynamically done. In other words, immediate data transmission from any one of the multiple cells included in the CoMP to the UE may be carried out. Further, scheduling including a beamforming function may be dynamically coordinated among the multiple cells, so that interference between different transmissions may be adjusted or reduced.

Further, joint processing/joint transmission allows data for a single UE to be transmitted from multiple cells at the same time. Accordingly, the quality of a received signal may be enhanced and interference may be reduced.

The uplink CoMP reception means receiving transmitted signals from multiple cells geographically separated from each other, and scheduling for each of the multiple cells is coordinated, thereby reducing interference.

Meanwhile, an RRH (Remote Radio Head) is a device constituted only of an RF (Radio Frequency) part and a baseband part that are split from a base station device, and the RRH may include, in addition to RF circuitry, an A/D (Analogue to Digital) converter, an up/down converter, etc. The RF part is separately provided, thus achieving a compact size. Accordingly, coverage may be expanded even without providing a separate base station, and a backhaul channel may be formed through a wired network connected to the base station. Further, the RRH may have the same cell ID as the base station.

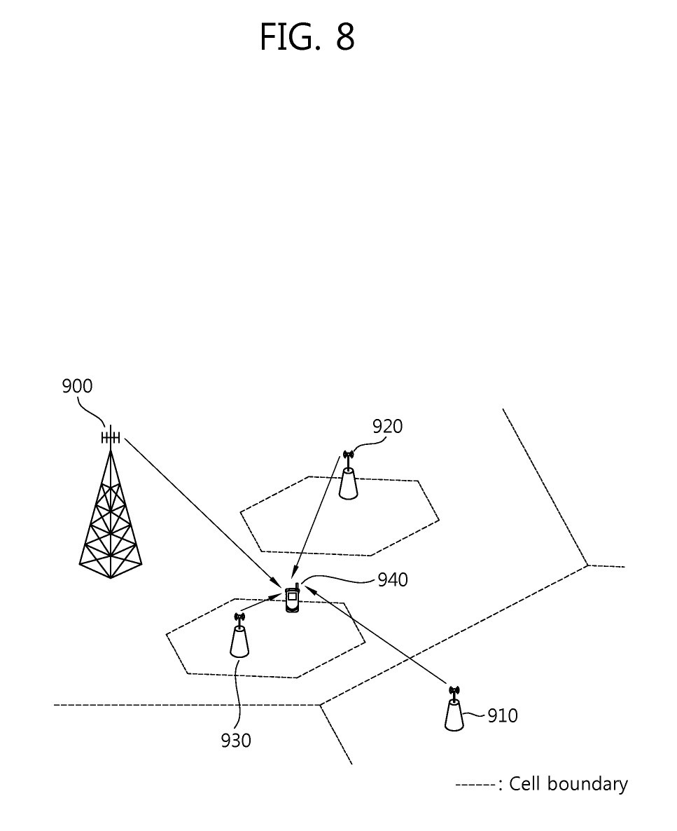

FIG. 8 illustrates an example of a system to which a CoMP applies and is a view schematically illustrating an example in which the present invention applies to a system constituted of a primary serving cell, an ambient cell, and an RRH.

FIG. 8 shows, as an example of a system to which a CoMP applies, a base station of a primary serving cell (primary base station, 900), a base station of an ambient cell (secondary base station, 910), and two RRHs 920 and 930 in the primary serving cell performing CoMP transmission on a UE 940.

Referring to FIG. 8, a communication link is established between the primary base station 900 and the UE 940, so that a PDCCH from the primary base station 900 is transmitted to the UE 940 obtains necessary control information from the PDCCH. As described above, the primary base station 900 is connected to each transmission point 920 or 930 through a backhaul channel. The primary base station 900 is connected with the secondary base station 910 through an X2 interface, and the primary base station 900 may be connected to the RRHs 920 and 930 through a wired network. The primary base station 900 may transmit and receive data and/or control information necessary for CoMP transmission to/from the secondary base station 910 and the RRHs 920 and 930 through wired channels.

Here, in association with resource allocation, control information on the secondary base station 910 and the RRHs 920 and 930 may be determined and transmitted by the primary base station 900 alone. Accordingly, control information transmitted from the primary base station 900 to the UE 940 on a PDCCH may include resource allocation information on each cell included in the CoMP.

The primary base station 900 forms a resource block group (resource block group for a sub group) by concatenating resource blocks (groups) for a plurality of cells (cell sub group) with respect to resource blocks allocated to each cell included in the CoMP and may deliver the size of the connected resource block group to the UE 940 through a single PDCCH.

In order to transmit information on resource block group size, like in the example of the component carrier, a UE-specific size information set may be used by upper layer signaling When receiving the size information set by upper layer signaling, the UE may verify the size of a resource block group corresponding to the information transmitted through a resource allocation field of the PDCCH from the size information set.

When configuring a size information set, the size of a resource block group is determined on cell sub groups that may be constituted from a set of cells included in the CoMP and a size information set may be then configured. The size information set may be a size information table constituted of cell sub groups, code points corresponding to the cell sub groups, and/or size of a combined resource block group for each cell sub group.

Meanwhile, the size P of a resource block group for a cell sub group may be determined by Equation 6 considering a cell combination, in addition to being delivered in a size information set as described above.

$$P = \frac{\begin{matrix}number of resource blocks \\ for all cells in cell sub group\end{matrix}}{ \begin{matrix}number of resource block groups \\ for predetermined reference cell\end{matrix}} \qquad [ Equation 6 ]$$

In case the size P of a resource block group is not an integer, the size P of a resource block group may be determined through the ┌P┐ operation. When A<P<=A+1(A is an integer), ┌P└ may be determined as A+1.

Here, the “all cells in cell sub group” refers to cells that are included in the CoMP, to which a resource block (group) is to be linked. Further, the “predetermined reference cell” may be a cell that uses a maximum band in a cell group, a cell using a predetermined specific band, a primary serving cell where a PDCCH is transmitted, or a cell indicated by a PDCCH.

Whether to use Equation 6 and which cell is to be used as the “predetermined reference cell” may be previously determined between the primary base station and the UE, and may be delivered to the UE through upper layer signaling.

The band used for each cell and the number of resource blocks according thereto, size of a resource block group, and number of resource block groups may be given as shown in Table 3 as in the case of component carriers.

Hereinafter, an example of the UE calculating the size of a resource block group through Equation 6 as in the case where the size of a resource block group is designated in an upper layer and is delivered to the UE through a primary base station is described with reference to FIG. 8.

In FIG. 8, assume that an RRH 930 and a secondary base station 910 are determined to be combined to link the resource blocks for the RRH 930 and the secondary base station 910, the RRH 930 uses a 10 MHz band (number of RBs=50), and the secondary base station 910 uses a 20 MHz band (number of RBs=100).

(Case 1) Size P of a Resource Block Group is Designated

Here, the primary base station 900 forms a resource block group by concatenating to resource blocks for the RRH 930 and the secondary base station 910 on a PDCCH and may designate the size P of a resource block group as 6 and transmit it.

(Case 2) Size P of a Resource Block Group is Determined Based on a Cell Group

Assume that the primary base station 900 uses a 15 MHz band, and a cell in the cell group, to which a maximum band is allocated, is defined as a reference cell. The UE may determine the size of a resource block group to be scheduled using Equation 6 and Table 3. Accordingly, since the secondary base station 910 uses 20 MHz and is the cell with the maximum band assigned, the secondary base station 910 is the reference cell (number of resource block groups=25). Thus, the size P of a resource block group to be scheduled is (100+50)/25=6.

In case a cell using a specific band, e.g., 10 MHz, is determined as reference cell, the size P of a resource block group is 9. In case a primary serving cell is determined as reference cell, the size P of a resource block group is 8.

Resource block group sizes may be delivered to the UE on a single PDCCH that is transmitted by the primary base station 1200. However, in case Equation 6 is used, even when the size of a resource block group is not explicitly delivered from the primary base station 900, the UE 940 may calculate the size of a resource block group from information on the cell sub group.

The primary base station 900 may configure a size information set with the resource block group sizes that may be scheduled and may deliver, to the UE on a PDCCH, a code point indicating the size of a resource block group that is to be allocated to the UE among the resource block group sizes constituting the size information set.

The size information set used to process information on the size of a resource block group between the primary base station and the UE may be configured in a size information table as shown in Table 10.

TABLE 10

| | | Size of resource block group |
|---|---|---|
| Code point | Cell sub group | for sub group (P) |
| A0 | Cell sub group 0 | P0 |
| A1 | Cell sub group 1 | P1 |
| . . . | . . . | . . . |

In a system to which CoMP transmission applies, the primary base station may indicate a cell sub group to be scheduled and the size of a resource block group for the cell sub group by sharing the size information set with the UE and transmitting a code point on the size information set to the UE. For example, if the primary base station transmits code point A0 on a PDCCH using Table 10, the UE may identify that the resource block group for cell sub group 0 has been allocated to have a size of P0.

Meanwhile, when using Equation 6, the size information set (size information table) used by the primary base station and the UE may be also configured with the size P of a resource block group excluded. Further, in the description above, the cell sub group may be configured of a single cell.

Here, a new field may be added to the PDCCH and this may be used to deliver information on the size of a resource block group that is transmitted on the PDCCH, or the information may also be transferred using a conventional field on the PDCCH. Or, a new field may be added, and this added field, together with the conventional field may be used to deliver the information.

In accordance with the number of bits of the field for transmitting the size of a resource block group, the number of code points and the size information set (size information table) may be configured differently. For example, in case the number of bits of a field for transmitting information on the size of a resource block group is 1, a size information set may be configured of code point 0 or 1 and information on two different sizes, and information on one of the two different sizes may be delivered to the UE. Further, in case the number of bits of the field for transmitting information on the size of a resource block group is 2, a size information set may be configured of four code points 00, 01, 10, and 11 and information on four different sizes and information on any one of the four different sizes may be delivered to the UE.

When utilizing conventional fields, the primary base station, as in the case of a component carrier, may transmit a code point corresponding to information on the size intended to be delivered to the UE, using a field that has been already specified but utilized yet. A conventional field that is already being used may also be added with a new field of one bit, and in case the added field is designated as 0, the conventional field may be used to fit its original purpose, or in case the added field is designated as 1, the conventional field may be used for transmitting resource allocation information.

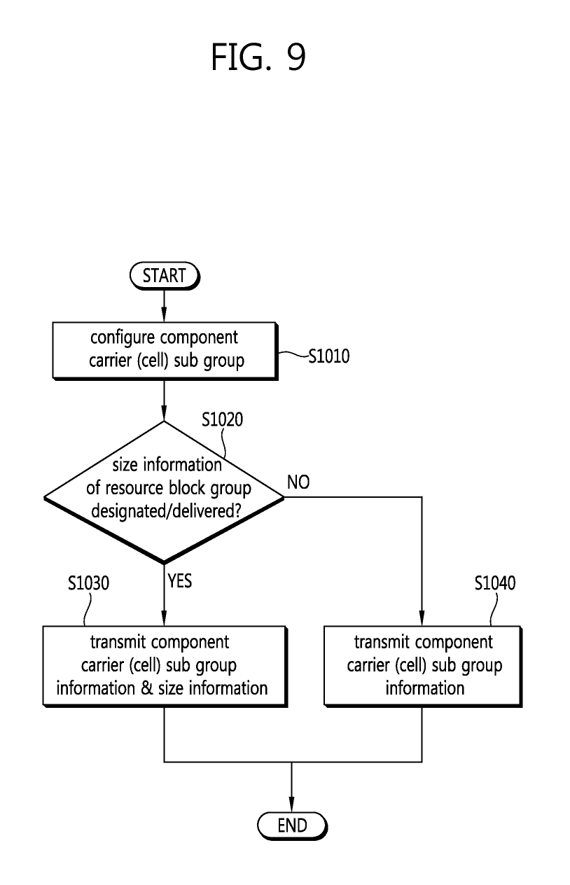

FIG. 9 is a flowchart schematically illustrating an operation performed by a base station in a system to which the present invention applies.

The base station configures a component carrier sub group from component carriers of a component carrier group (S1010). In the case of a CoMP system, the base station operates as a primary base station and configures a cell sub group from among the cells (cells in a cell group) included in the CoMP.

The base station determines whether to designate information on the size of a resource block group and deliver it to the UE (S1020). The base station may transmit, to the UE on a PDCCH, control information including information regarding resource allocation. The information regarding resource allocation is UE-specific information, and this information may include information on a component carrier sub group or may include information on the size of a resource block group for the sub group, together with the information on the resource allocation.

Meanwhile, even when CoMP applies, the base station, as a primary base station of the CoMP system, may transmit control information including information on resource allocation on a PDCCH to the UE. The information on resource allocation is UE-specific information and may include information on a cell sub group or may include, together with the information on the cell sub group, information on the size of a resource block group for the sub group.

The information on resource allocation transmitted between the base station and the UE may be transmitted using a size information set of a resource block group, and here, the size information set may be a size information table constituted of information on a component carrier (or cell) sub group and/or size of a resource block group for the sub group, and a corresponding code point. The size information set (size information table) may be previously delivered to the UE through upper layer signaling (MAC or RRC), and the base station, as described above, may deliver resource allocation information to the UE by selecting a code point indicating a resource block group to be allocated on the size information set (size information table) and transmitting it to the UE.

When designating and delivering the size of a resource block group for a component carrier sub group (or cell sub group), the base station transmits, to the UE, the size of a resource block group for the sub group along with information on the component carrier sub group or cell sub group (S1030).

Unless designating and delivering information on the size of a resource block group for a component carrier sub group (or cell sub group), the base station transmits information on the component carrier sub group or cell sub group to the UE (S1040). Here, the UE may obtain the size of a resource block group for the sub group using Equation 4 or 6.

Determining whether to designate and deliver the size of a resource block group after configuring a component carrier (cell) sub group has been described, and the present invention is not limited thereto. After determining whether to designate and deliver the size of a resource block group, a component carrier (cell) sub group may be configured. Further, whether to designate and deliver the size of a resource block group, rather than being dynamically determined, may be determined in advance in, e.g., an upper layer.

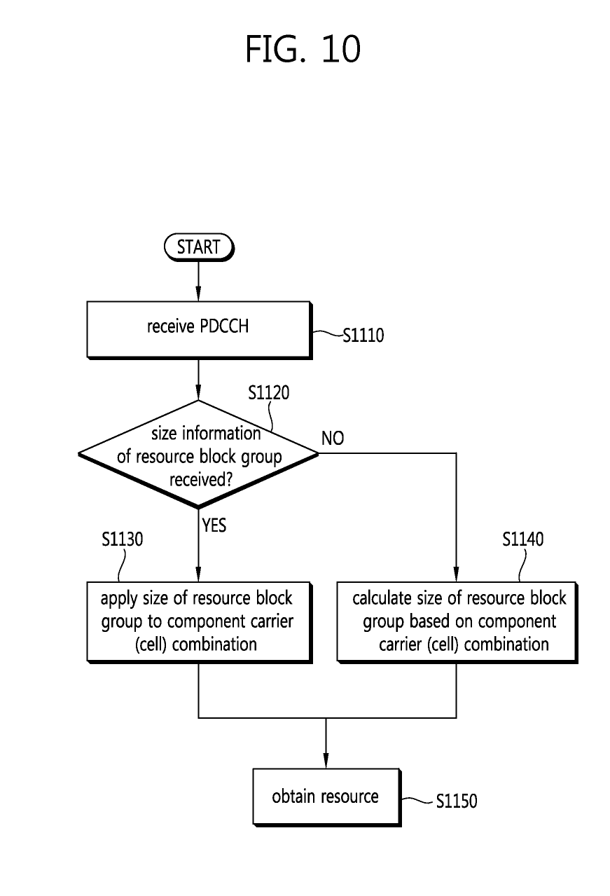

FIG. 10 is a flowchart schematically illustrating an operation performed by a UE in a system to which the present invention applies.

Referring to FIG. 10, the UE receives control information regarding resource allocation on a PDCCH (S1110).

Here, the UE may identify whether the received control information includes information on the size of a resource block group (S1120). The control information may include only information regarding a component carrier sub group or may include information on a component carrier sub group and information on the size of a resource block group corresponding to the sub group. In the case of a CoMP system, the control information may include only information on a cell sub group or may include information on a cell sub group and information on the size of a resource block group corresponding to the cell sub group.

The information regarding resource allocation transmitted between the base station and the UE may be transmitted using a size information set of a resource block group. The size information set (size information table) may be previously delivered to the UE through upper layer signaling (MAC or RRC), and the UE may obtain a resource block group indicated by the received code point on the size information set (size information table) as described above.

When receiving the information on the size of a resource block group, the UE applies the received size information to a resource block group for a component carrier (cell) sub group included in the control information (S1130).

Unless receiving information on the size of a resource block group, the UE calculates the size of a resource block group for a component carrier (cell) sub group included in the control information (S1140). Here, the UE may calculate the size of a resource block group using Equation 4 for a component carrier sub group and Equation 6 for a cell sub group.

Determining whether the UE is to calculate the size of a resource block group depending on whether to receive information on the size of a resource block group has been described herein for ease of description. Whether the size of a resource block group is calculated by the UE may be determined through upper layer signaling, and the UE may or may not calculate the size information according to an indication of upper layer signaling regardless of whether the information on the size of a resource block group is present in the received control information.

The UE may obtain a resource allocated through control information on a PDCCH (S1150). When receiving the size of a resource block group, the UE may obtain a resource block group having the size indicated by the received size information as a resource block group (resource block group for a sub group) configured by concatenating resource block groups for component carriers (cells) of a component carrier (cell) sub group.

Unless receiving the size of a resource block group, the UE may obtain a resource block group having the size calculated by Equation 4 or Equation 6 as a resource block group (resource block group for a sub group) configured by concatenating resource block groups for component carriers (cells) of a component carrier (cell) sub group included in the control information.

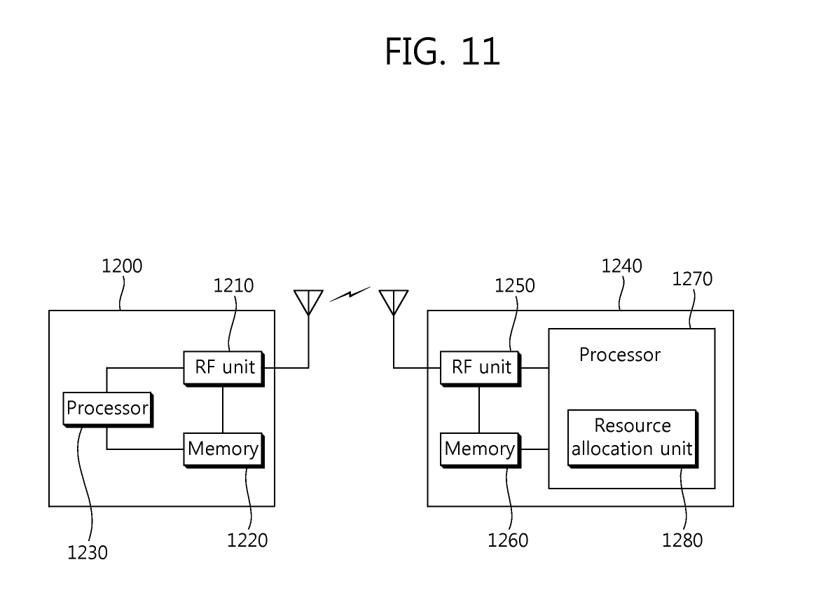

FIG. 11 is a block diagram schematically illustrating the configuration of a UE and a base station in a system to which the present invention applies.

Referring to FIG. 11, the UE 1200 includes an RF unit 1210, a memory 1220, and a processor 1230.

The UE 1200 communicates with a base station through the RF unit 1210. In a CoMP system, when CoMP transmission applies to the UE 1200, the UE 1200 may perform communication with multiple cells through the RF unit 1210.

The memory 1220 stores information necessary for the UE 1200 to perform communication in the system. For example, the memory 1220 may store a size information set that is shared with the base station with respect to resource allocation in order to obtain a resource. The size information set may be received via the RF unit 1210 through upper layer signaling.

The processor 1230 is connected to the RF unit 1210 and the memory 1220 and controls the RF unit 1210 and the memory 1220 and may perform the functions suggested herein. The processor 1230 may obtain a resource to be used for uplink transmission in accordance with control information on the PDCCH transmitted from the base station. The processor 1230 may configure a resource block group for a component carrier or cell sub group indicated by the information delivered through the resource allocation field of the PDCCH and may obtain a resource according to the size of a resource block group as indicated or calculated.

The base station 1240 includes an RF unit 1250, a memory 1260, and a processor 1270. The base station 1240 transmits and receives necessary information through the RF unit 1250. For example, the base station 1240 may transmit control information regarding resource allocation on a PDCCH through the RF unit 1250 or may transmit upper layer signaling. Meanwhile, in the case of a CoMP system, the base station 1240 operates as a primary base station and may perform transmission and reception using the RF unit 1250 including an RRH inside or outside the cell.

The memory 1260 may store information necessary for the base station 1240 to operate the system. For example, the memory 1260 may store a size information set shared with the UE 1200 with respect to resource allocation. The size information set may be transmitted to the UE 1200 via the RF unit 1250 through upper layer signaling. In a CoMP system, the memory 1260 may store information of each cell that is received through a backhaul channel.

The processor 1270 is connected to the RF unit 1250 and the memory 1260 and controls the RF unit 1250 and the memory 1260 and may perform the functions suggested herein. Further, a resource allocation unit 1280 may be included that performs an operation regarding resource allocation.

The processor 1270 or the resource allocation unit 1280 included in the processor 1270 may designate a predetermined component carrier sub group in a carrier aggregation environment, allocate a resource block group for the component carrier sub group to the UE 1200, and deliver information thereon to the UE 1200. Further, the processor 1270 or the resource allocation unit 1280 included in the processor 1270 may designate a predetermined cell sub group in a CoMP system, allocate a resource block group for the cell sub group, and deliver information thereon to the UE 1200.

Here, the processor 1270 or the resource allocation unit 1280 included in the processor 1270 may deliver information necessary for resource allocation to the UE using the size information set stored in the memory 1260.

In a communication scheme requiring many PDCCHs, such as the multiple user (MU)-MIMO scheme or CoMP scheme, the number of PDCCHs that may be provided in an existing control region may be limited. Accordingly, in order to maximize the efficiency of a PDCCH in the existing communication scheme and a PDCCH in the MU-MIMO or CoMP scheme, a method is required to allocate resources for one or more PDSCHs in a component carrier, a cell, or a transmission point using one PDCCH. Here, the transmission point is the concept including all of a base station, a pico base station, a femto base station, or a remote radio head (RRH). When a PDCCH being limited to indicate only one PDSCH for one component carrier, one cell, or one transmission point is expanded to indicating multiple PDSCHs, a range of PDSCH allocation that may be obtained in a limited resource of control region may be enlarged.

One PDCCH indicating two or more PDSCHs may be referred to as PDCCH bundling, and such PDCCH is referred to as a bundling PDCCH. Two methods may be supported for PDCCH bundling.

1. Method of Configuring New DCI

When following PDCCH bundling, the amount of information of the existing DCI may increase or new control information may be needed. However, adding a new field to the existing fields in the DCI may result in a change in the DCI format. This increases complexity of blind decoding that is a process of extracting the DCI format from the PDCCH. Blind decoding is a decoding scheme in which a predetermined start point of decoding is defined in a predetermined PDCCH region, decoding is performed on all of the DCI formats as possible in a given transmission mode, and control information for distinguishing users is decoded from a C-RNTI (Cell-Radio Network Temporary Identifier) masked to the CRC. In blind decoding, the complexity of decoding increases depending on the number of DCI formats to be decoded, and a difference in the DCI size means that the number of DCI formats to be decoded increases. Further, an increase in the size of a PDCCH leads to a deterioration of PDCCH performance.

Under such circumstance, a scheme of configuring a new transmission mode may be considered in order to prevent complexity of blind decoding from increasing. Such configuration of a new transmission mode means a large increase in the number of transmission modes and may render transmission and reception processes more complicated.

Accordingly, it is preferable to allow the size of a new DCI format mapped to the bundling PDCCH to be maintained as the size of the existing DCI format or to define a new DCI format having a slight increase in size, replacing the existing DCI format. By doing so, the existing one may be brought up without addition of a new transmission mode.

For instance, it may be assumed that transmission mode 1 denotes a single antenna transmission mode and blind decoding is performed on DCI formats 0/1A (small size) and DCI format 1 (large size). A new DCI format indicating two PDSCHs having the same size as DCI format 1 may be defined. Various compression schemes may be used to fit a new DCI format to the size of DCI format 1.

As an example, as described above, the size of a resource block to which a PDSCH is mapped may be changed.

As another example, a pattern for allocating a resource to which a PDSCH is mapped may be changed to be represented in fewer bits.

As still another example, an existing method of indicating a resource in a bitmap like the type 0 resource allocation scheme is changed to a method of indicating multiple contiguous resource blocks like the type 2 resource allocation scheme. For example, in case the system bandwidth is 10 MHz, 50 resource blocks (or 17 resource block groups (RBGs) may be allocated to a data region. According to type 0, a resource block to which one PDSCH is mapped may be represented in a 17 bit long bitmap. Here, when the size of a resource block group is 2, and 25 resource block groups (25 RBGs×2 (RBs/RBG)=50 RBs) is allocated to type 2, resource block groups to which a first PDSCH is mapped may be represented in the number of 25×26/2=325 cases, and resource block groups to which a second PDSCH is mapped may be represented in the number of 25×26/2=325 cases. When a PDCCH indicates both the first PDSCH and the second PDSCH by bundling, it should represent a total of 325×325=105625<131072=2¹⁷ cases, and thus, a total of 17 bits is required. While in type 0 one PDCCH indicates only one PDSCH with 17 bits, one PDSCH in type 2 may indicate two PDSCHs with 17 bits. Such scheme may also apply to other DCI formats that adopt bitmap-type resource allocation like DCI formats 2/2A/2B/2C.

As still another example, an MCS value of DCI mapped to one bundling PDCCH jointly applied to multiple PDSCHs.

As still another example, HARQ parameters of DCI mapped to one bundling PDCCH may be applied jointly or independently to multiple PDSCHs. Here, the HARQ parameters include a new data indicator (NDI) a redundancy version (RV), and a HARQ index.

For example, in case each PDSCH is configured to undergo an independent HARQ process, the HARQ parameters of DCI mapped to the bundling PDCCH are applied to only one PDSCH. Here, assuming that multiple PDSCHs always transmit new data, some or all of the HARQ parameters may be omitted or have a specific value. For example, the new data indicator may be omitted, the redundancy version may be previously defined to be set as a specific value, and the HARQ index may also be previously defined to be set as an initial value. As such, in case multiple PDSCHs are indicated by the bundling PDCCH to configure a HARQ process, the HARQ parameters need not be transmitted in duplicate, so that the overhead of control information may be reduced, and the configuration of a new DCI format may be simply implemented. This means that in the case of the bundling PDCCH, an example in which its use is limited to first transmission always constituted of new data may apply. Such embodiment is advantageous in light of the fact that the first transmission takes up a majority (90% or more) of data transmission. Further, as set forth above, when a new DCI format mapped to the bundling PDCCH is configured to fit the size of the existing DCI format, the transmission mode for specifying a transmission scheme may be used likewise. Or, as described above, the size of the existing PDCCH may be changed and replaced by a new PDCCH. In case a common HARQ parameter is used for multiple PDSCHs, an ACK/NACK signal may be transmitted by any one of the following methods.

First, each of the multiple PDSCHs includes a cyclic redundancy check (CRC) bit. The UE outputs a final ACK/NACK signal by performing a logical AND operation on a result (if ACK, 1 and if NACK, 0) obtained by conducting an error check with a CRC bit in each PDSCH. Such process is referred to as ACK/NACK bundling. For example, if ACK for PDSCH1, NACK(0) for PDSCH2, and ACK for PDSCH3, then (ACK) AND (NACK) AND (ACK)=NACK. Accordingly, the UE transmits an NACK signal to the base station. For example, as described above, when two component carriers are represented in one resource allocation, so that it is allocated to each component carrier in the form of a contiguous one cluster (bundle of contiguous resource blocks), a CRC bit may be included in each PDSCH but may also proceed in one HARQ process.

Second, among multiple PDSCHs indicated by the bundling PDCCH of a plurality of PDSCHs, the last PDSCH only includes a CRC bit. Accordingly, the UE, after checking a CRC error only on the last PDSCH, generates an ACK/NACK signal and transmits it to the base station.

In contrast, in case multiple PDSCHs are configured so that the PDSCHs are combined and go through one HARQ process, the HARQ parameters of DCI mapped to the bundling PDCCH jointly apply to the multiple PDSCHs. As such, in case a HARQ process is configured by indicating multiple PDSCHs with separate PDCCHs different from each other, HARQ parameters are individually required, and a DCI format having a relatively large size needs to be configured. Further, the configuration of a DCI format having a large size is difficult to fit to an existing DCI format with poor transmission quality of a control channel.

Third, multiple PDSCHs transmit their respective ACK/NACK information so as to perform an independent HARQ process for each PDSCH. This causes a negative influence in light of compression of control information, but gains advantage from the point of view of data throughput. In such case, the existing communication standards may be significantly affected.

2. Method for Identifying Bundling PDCCH

A simple approach is to use one bit of a PDCCH as an identifier bit for identifying a bundling PDCCH and a general PDCCH. For example, in case the identifier bit is 0, it may denote an existing PDCCH operation, and in case the identifier bit is 1, it may denote the bundling PDCCH. In such case, more complicated parameters may be delivered through an increase in the number of bits. Or, as an identifier bit for identifying a bundling PDCCH and a general PDCCH, a CIF may be used. As described above, the CIF may be used to indicate resource regions connected in series over multiple component carriers in configuring a resource space. This also means identifying that a PDCCH including the CIF is a bundling PDCCH with respect to multiple PDSCHs mapped to the resource regions connected in series.

A CIF is a field for differentiating component carriers and indicates not only a single component carrier but also multiple component carriers or multiple cells or multiple transmission points. In case the CIF has, e.g., three bits, it may indicate 0, 1, 2, . . . , 7. Here, among the values of the CIF, values 0 to 4 identify a single component carrier, and values 5 to 7 identify multiple component carriers or multiple cells or multiple transmission points. That is, a specific range of the CIF values indicate multiple component carriers or multiple cells or multiple transmission points. Meanwhile, if the CIF values indicate 5 to 7, it should represent that the corresponding DCI is mapped to the bundling PDCCH. By doing so, the bundling PDCCH and a general PDCCH may be identified. Further, if the UE receives a DCI-mapped PDCCH including a CIF indicating multiple component carriers, the UE may recognize the corresponding PDCCH as a bundling PDCCH.

For example, in case the number of component carriers configured in the UE is 3, CIF values 0 to 2 are allocated to individual component carriers, and CIF values 3 to 7 may be defined as a combination of multiple component carriers, a combination of multiple cells or a combination of multiple transmission points as shown in the following table:

TABLE 11

| | Combination of | | Combination of |
|---|---|---|---|
| | multiple component | Combination of | multiple |
| CIF | carrier | multiple cells | transmission points |
| 0 | CC0 | PCell | TP0 |
| 1 | CC1 | SCell 0 | TP1 |
| 2 | CC2 | SCell 1 | TP2 |
| 3 | CC0, CC1 | SCell 0, SCell 1 | TP0, TP1 |
| 4 | CC0, CC2 | SCell 0, SCell 2 | TP0, TP2 |
| 5 | CC1, CC2 | SCell 1, SCell 2 | TP1, TP2 |
| 6 | CC0, CC1, | SCell 0, SCell 1, | TP0, TP1, |
| | CC2 | SCell 2 | TP2 |
| 7 | N.A. | N.A. | N.A. |

Referring to Table 11, CIF values 0, 1, and 2 respectively indicate CC0, CC1, and CC2. If the CIF value is 4, this means that the bundling PDCCH indicates both a PDSCH on CC0 and a PDSCH on CC2.

Or, CIF values 0, 1, and 2 respectively indicate PCell, SCell0, and SCell1, and CIF values 3, 4, 5, 6, and 7 respectively indicate multiple cells combinations (SCell0, SCell1), (SCell0, SCell2), (SCell1, SCell2), and (SCell0, SCell1, SCell2). That is, CIF values 3 to 7 represents that the bundling PDCCH indicates all of multiple PDSCHs in each of the multiple cells. Here, PCell is a primary serving cell, and SCell is a secondary serving cell. PCell means a serving cell that provides a security input and NAS mobility information under RRC establishment or re-establishment. According to capabilities of the UE, at least one cell, together with a PCell, may be configured to form a serving cell set, and here, the at least one cell is referred to as SCell. Accordingly, a serving cell set configured for one UE may be constituted of one PCell only or one PCell and at least one SCell. A downlink component carrier corresponding to the PCell is referred to as a downlink primary component carrier (DL PCC), and an uplink component carrier corresponding to the PCell is referred to as an uplink primary component carrier (UL PCC). Further, on downlink, a component carrier corresponding to the SCell is referred to as a downlink secondary component carrier (DL SCC), and on uplink, a component carrier corresponding to the SCell is referred to as an uplink secondary component carrier (UL SCC).

Or, CIF values 0, 1, and 2 respectively indicate TP0, TP1, and TP2, and CIF values 3, 4, 5, 6, and 7 respectively indicate multiple transmission points combinations (TP0, TP1), (TP0, TP2), (TP1, TP2), and (TP0, TP1, TP2). That is, CIF values 3 to 7 represent that the PDCCH indicates all of the multiple PDSCHs in each of the multiple transmission points.

Combinations of the respective components of component carriers, cells, and transmission points have been described. An embodiment of an indicator for a combination of such components may also be made. For example, an embodiment such as (CC0, SCell 1,TP1,TP2) may also be possible.

As described above, the present invention may apply when different resource allocation information is transmitted through a single control channel with respect to multiple component carriers, coordinated cells (sites), coordinated RRHs, or coordinated relays in a CoMP system under a carrier aggregation environment.

What has been described thus far is merely an example of description of the technical spirit of the present invention, and various changes or modifications may be made thereto by those skilled in the art without departing from the essential features of the present invention.

The embodiments disclosed herein are provided to, rather than limit, describe the technical spirit of the present invention and the scope of the technical spirit of the present invention is not limited thereto. The scope of the present invention should be interpreted by the following claims and all technical spirit within its equivalents should be construed as included in the scope of the present invention.

1. A method of transmitting resource allocation information by a base station, the method comprising:
configuring at least one component carrier for a user equipment (UE); and
transmitting resource allocation information through a single control channel, the resource allocation information indicating resource blocks concatenated over the at least one component carrier and allocated to a data channel,
wherein the resource allocation information includes information on a size of a resource block group defining a basis on which the concatenated resource blocks are allocated.

2. The method of claim 1, wherein a group of component carriers consists of cells selected from coordinated cells in a coordinated multiple point (CoMP) system, wherein the coordinated cells include at least one of a primary serving cell, a neighboring cell of the primary serving cell, a micro cell inside or outside the primary serving cell, a remote radio head (RRH) inside or outside the primary serving cell, and a relay inside or outside the primary serving cell.

3. The method of claim 1, wherein the resource allocation information is represented as a code point, and the code point indicates a size of a resource block group applied to a group constituted of the at least one component carrier.

4. The method of claim 1, wherein the size of a resource block group is determined as a size of a resource block group defined in a band of a basic component carrier of the at least one component carrier.

5. A method of receiving resource allocation information by a user equipment (UE), the method comprising:
configuring at least one component carrier; and
receiving resource allocation information through a single control channel, the resource allocation information indicating resource blocks concatenated over the at least one component carrier and allocated to a data channel,
wherein the resource allocation information includes information on a size of a resource block group defining a basis on which the concatenated resource blocks are allocated.

6. The method of claim 5, wherein a group of component carriers consists of cells selected from coordinated cells in a coordinated multiple point (CoMP) system, wherein the coordinated cells include at least one of a primary serving cell, a neighboring cell of the primary serving cell, a micro cell inside or outside the primary serving cell, a remote radio head (RRH) inside or outside the primary serving cell, and a relay inside or outside the primary serving cell.

7. The method of claim 5, wherein the resource allocation information is represented as a code point, and the code point indicates a size of a resource block group applied to a group constituted of the at least one component carrier.

8. The method of claim 5, wherein the size of a resource block group is determined as a size of a resource block group defined in a band of a basic component carrier of the at least one component carrier.

9. A base station to transmit resource allocation information, the base station comprising:
a processor to configure at least one component carrier for a user equipment (UE); and
a radio frequency (RF) unit to transmit resource allocation information through a single control channel, the resource allocation information indicating resource blocks concatenated over the at least one component carrier and allocated to a data channel,
wherein the resource allocation information includes information on a size of a resource block group defining a basis on which the concatenated resource blocks are allocated.

10. The base station of claim 9, wherein a group of component carriers consists of cells selected from coordinated cells in a coordinated multiple point (CoMP) system, wherein the coordinated cells include at least one of a primary serving cell, a neighboring cell of the primary serving cell, a micro cell inside or outside the primary serving cell, a remote radio head (RRH) inside or outside the primary serving cell, and a relay inside or outside the primary serving cell.

11. The base station of claim 9, wherein the resource allocation information is represented as a code point, and the code point indicates a size of a resource block group applied to a group constituted of the at least one component carrier.

12. The base station of claim 9, wherein the size of a resource block group is determined as a size of a resource block group defined in a band of a basic component carrier of the at least one component carrier.

13. A user equipment (UE) to receive resource allocation information, the UE comprising:
a processor to configure at least one component carrier; and
a radio frequency (RF) unit to receive resource allocation information through a single control channel, the resource allocation information indicating resource blocks concatenated over the at least one component carrier and allocated to a data channel,
wherein the resource allocation information includes information on a size of a resource block group defining a basis on which the concatenated resource blocks are allocated.

14. The UE of claim 13, wherein a group of component carriers consists of cells selected from coordinated cells in a coordinated multiple point (CoMP) system, wherein the coordinated cells include at least one of a primary serving cell, a neighboring cell of the primary serving cell, a micro cell inside or outside the primary serving cell, a remote radio head (RRH) inside or outside the primary serving cell, and a relay inside or outside the primary serving cell.

15. The UE of claim 13, wherein the size of a resource block group is determined as a size of a resource block group defined in a band of a basic component carrier of the at least one component carrier.
